(19) United States
(12) Patent Application Publication
(10) Pub. No.: US 2013/0288897 A1
(43) Pub. Date: Oct. 31, 2013

(54) SYNERGISTIC PESTICIDAL COMPOSITIONS

(71) Applicant: Dow AgroSciences LLC, Indianapolis, IN (US)

(72) Inventors: Jonathan M. Babcock, Carmel, IN (US); Catherine D. Young, Indianapolis, IN (US); James E. King, Carmel, IN (US); Mary E. Kubiszak, Indianapolis, IN (US)

(73) Assignee: Dow AgroSciences LLC, Indianapolis, IN (US)

(21) Appl. No.: 13/870,096

(22) Filed: Apr. 25, 2013

Related U.S. Application Data
(60) Provisional application No. 61/640,432, filed on Apr. 30, 2012.

(51) Int. Cl. A01N 47/40; A01N 57/20

(52) U.S. Cl. CPC A01N 47/40; A01N 57/20
USPC 504/206

(57) ABSTRACT

Synergistic pesticidal compositions including a pesticide/herbicide mixture are provided.

### CROSS-REFERENCE TO RELATED APPLICATIONS

The present application claims priority to U.S. Provisional Patent Application No. 61/640,423 filed Apr. 30, 2012, the content of which is incorporated herein by reference in its entirety.

### FIELD OF THE INVENTION

The present application is related to the field of pesticides and their use in controlling pests.

### BACKGROUND OF THE INVENTION

Pests cause millions of human deaths around the world each year. Furthermore, there are more than ten thousand species of pests that cause losses in agriculture. These agricultural losses amount to billions of U.S. dollars each year. Termites cause damage to various structures such as homes. These termite damage losses amount to billions of U.S. dollars each year. As a final note, many stored food pests eat and adulterate stored food. These stored food losses amount to billions of U.S. dollars each year, but more importantly, deprive people of needed food.

Insects are developing resistance to pesticides in current use. Hundreds of insect species are resistant to one or more pesticides. The development of resistance to some of the older pesticides, such as DDT, the carbamates, and the organophosphates, is well known. But resistance has even developed to some of the newer pesticides. Therefore, there is an acute need for new and/or improved pesticides.

### SUBSTITUENTS

### Non-Exhaustive List

The examples given for the substituents are (except for halo) non-exhaustive and must not be construed as limiting the invention disclosed in this document.

“alkoxy” means an alkyl further consisting of a carbon-oxygen single bond, for example, methoxy, ethoxy, propoxy, isopropoxy, 1-butoxy, 2-butoxy, isobutoxy, tert-butoxy, pentoxy, 2-methylbutoxy, 1,1-dimethylpropoxy, hexoxy, heptoxy, octoxy, nonoxy, and decoxy.

“alkyl” means an acyclic, saturated, branched or unbranched, substituent consisting of carbon and hydrogen, for example, methyl, ethyl, propyl, isopropyl, 1-butyl, 2-butyl, isobutyl, tert-butyl, pentyl, 2-methylbutyl, 1,1-dimethylpropyl, hexyl, heptyl, octyl, nonyl, and decyl.

“halo” means fluoro, chloro, bromo, and iodo.

“haloalkyl” means an alkyl further consisting of, from one to the maximum possible number of, identical or different, halos, for example, fluoromethyl, difluoromethyl, trifluoromethyl, 1-fluoromethyl, 2-fluoroethyl, 2,2,2-trifluoroethyl, chloromethyl, trichloromethyl, and 1,1,2,2-tetrafluoroethyl.

### BRIEF DESCRIPTION OF THE FIGURES

FIG. 1 is a bar graph illustrating LC50/90 Cotton Aphid values of different compositions.

FIG. 2 is a bar graph comparing expected and measured Cotton Aphid control rates.

### DETAILED DESCRIPTION OF THE INVENTION

Pesticide compositions have been surprisingly discovered where one or more pesticide compounds of the following formula are synergistic with one or more herbicides.

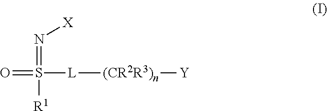

wherein

X represents NO₂, CN or COOR⁴;

L represents a single bond or R¹, S and L taken together represent a 5- or 6-membered ring;

R¹ represents methyl or ethyl;

R² and R³ independently represent hydrogen, methyl, ethyl, fluoro, chloro or bromo;

n is an integer from 0-3;

Y represents 6-halopyridin-3-yl, 6-(C₁-C₄)alkylpyridin-3-yl, 6-halo(C₁-C₄)alkylpyridin-3-yl, 6-(C₁-C₄)alkoxypyridin-3-yl, 6-halo(C₁-C₄)alkoxypyridin-3-yl, 2-chlorothiazol-4-yl, or 3-chloroisoxazol-5-yl when n=0-3 and L represents a single bond, or Y represents hydrogen, C₁-C₄ alkyl, phenyl, 6-halopyridin-3-yl, 6-(C₁-C₄)alkylpyridin-3-yl, 6-halo(C₁-C₄)alkylpyridin-3-yl, 6-(C₁-C₄)alkoxypyridin-3-yl, 6-halo(C₁-C₄)alkoxypyridin-3-yl, 2-chlorothiazol-4-yl, or 3-chloroisoxazol-5-yl when n=0-1 and R¹, S and L taken together represent a 5- or 6-membered ring; and

R⁴ represents C₁-C₃ alkyl.

Methods for the preparation of sulfoximines, other than those described in Scheme H, have been previously disclosed in U.S. Patent Publication No. 2005/0228027, the contents of which are hereby incorporated herein by reference in their entirety.

The compounds of formula (Ia), wherein R¹, R², R³, R⁴, X, and Y are as previously defined and L is a single bond, can be prepared by the methods illustrated in Scheme A:

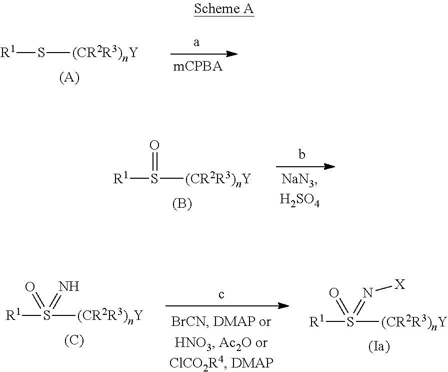

In step a of Scheme A, sulfide of formula (A) is oxidized with meta-chloroperoxybenzoic acid (mCPBA) in a polar solvent below 0° C. to provide sulfoxide of formula (B). In most cases, dichloromethane is the preferred solvent for oxidation.

In step b of Scheme A, sulfoxide (B) is iminated with sodium azide in the presence of concentrated sulfuric acid in an aprotic solvent under heating to provide sulfoximine of formula (C). In most cases, chloroform is the preferred solvent for this reaction.

In step c of Scheme A, the nitrogen of sulfoximine (C) can be either cyanated with cyanogen bromide in the presence of a base, or nitrated with nitric acid in the presence of acetic anhydride under mildly elevated temperature, or carboxylated with alkyl (R⁴) chloroformate in the presence of base such as 4-dimethylaminopyridine (DMAP) to provide N-substituted sulfoximine (Ia). Base is required for efficient cyanation and carboxylation and the preferred base is DMAP, whereas sulfuric acid is used as catalyst for efficient nitration reaction.

The compounds of formula (Ia), wherein X represents CN and R¹, R², R³, R⁴ and Y are as previously defined, can be prepared by the mild and efficient method illustrated in Scheme B.

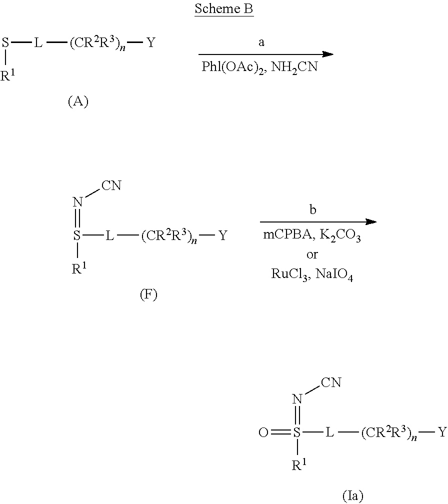

In step a of Scheme B, sulfide is oxidized with iodobenzene diacetate in the presence of cyanamide at 0° C. to give sulfilimine (F). The reaction can be carried out in a polar aprotic solvent like dichloromethane.

In step b of Scheme B, the sulfilimine (F) is oxidized with mCPBA. A base such as potassium carbonate is employed to neutralize the acidity of mCPBA. Protic polar solvents such as ethanol and water are used to increase the solubility of the sulfilimine starting material and the base employed. The sulfilimine (F) can also be oxidized with aqueous sodium or potassium periodinate solution in the presence of catalyst ruthenium trichloride hydrate or similar catalyst. The organic solvent for this catalysis can be polar aprotic solvent such as dichloromethane, chloroform, or acetonitrile.

The α-carbon of the N-substituted sulfoximine of formula (Ia), i.e., n=1, R³═H in the (CR²R³) group adjacent to the N-substituted sulfoximine function can be further alkylated or halogenated (R⁵) in the presence of a base such as potassium hexamethyldisilamide (KHMDS) to give N-substituted sulfoximines of formula (Ib), wherein R¹, R², R³, R⁴, X, L and Y are as previously defined and Z is an appropriate leaving group, as illustrated in Scheme C. The preferred leaving groups are iodide (R⁵=alkyl), benzenesulfonimide (R⁵═F), tetrachloroethene (R⁵═Cl), and tetrafluoroethene (R⁵=Br).

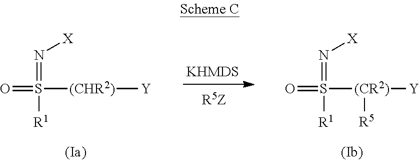

The starting sulfides (A) in Scheme A can be prepared in different ways as illustrated in Schemes D, E, F G, H, and I.

In Scheme D, the sulfide of formula (A₁), wherein R¹, R² and Y are as previously defined, n=1, and R³═H, can be prepared from the chloride of formula (D₁) by nucleophilic substitution with the sodium salt of an alkyl thiol.

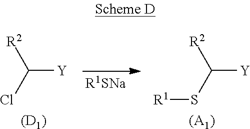

In Scheme E, the sulfide of formula (A₂), wherein R¹, R² and Y are as previously defined, n=3, and R³═H, can be prepared from the chloride of formula (D₂) by reacting with a 2-mono substituted methyl malonate in the presence of base such as potassium tert-butoxide to provide 2,2-disubstituted malonate, hydrolysis under basic conditions to form a diacid, decarboxylation of the diacid by heating to give a monoacid, reduction of the monoacid with borane-tetrahyrofuran complex to provide an alcohol, tosylation of the alcohol with toluenesulfonyl chloride (tosyl chloride) in the presence of a base like pyridine to give a tosylate and replacement of the tosylate with the sodium salt of the desired thiol.

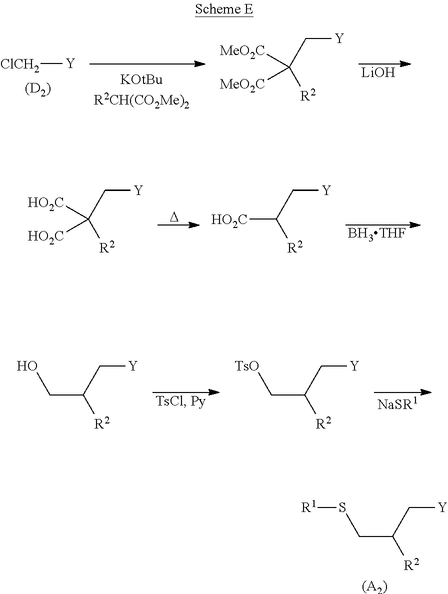

In Scheme F, the sulfide of formula (A₃), wherein R¹, R² and Y are as previously defined, n=2, and R³═H, can be prepared from the nitrile of formula (E) by deprotonation with a strong base and alkylation with an alkyl iodide to give α-alkylated nitrile, hydrolysis of the α-alkylated nitrile in the presence of a strong acid like HCl to give an acid, reduction of the acid with borane-tetrahydrofuran complex to provide an alcohol, tosylation of the alcohol with tosyl chloride in the presence of a base like pyridine to give a tosylate and replacement of the tosylate with the sodium salt of the desired thiol.

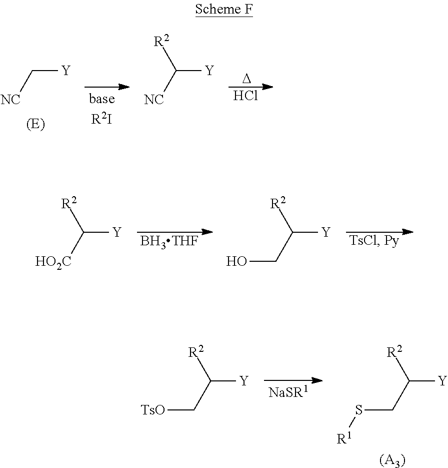

In Scheme G, the sulfide of formula (A₄), wherein R¹, S and L taken together form a ring, n=0, and Y=isopropyl or phenyl can be prepared from the unsubstituted cyclic sulfide wherein m=0, 1. Chlorination of the cyclic sulfide starting material with N-chlorosuccinimide in benzene followed by alkylation with Grignard reagent can lead to the desired sulfide (A₄) in satisfactory yield.

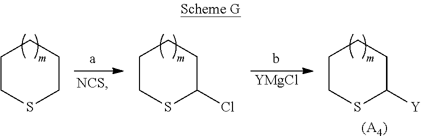

An alternative method for the preparation of sulfides of formula (A₄), wherein R¹, S and L taken together form a ring, n=0, m=0, and Y=6-halo, 6-(C₁-C₄)alkyl, 6-(C₁-C₄)haloalkyl or 6-(C₁-C₄)alkoxy substituted 3-pyridyl is highlighted in Scheme H. Accordingly, the corresponding appropriately substituted chloromethylpyridine is treated with thiourea, hydrolyzed and subsequently alkylated with 1-bromo-3-chloropropane under aqueous base conditions, and cyclized in the presence of a base like potassium tert-butoxide in a polar aprotic solvent such as tetrahydrofuran (THF).

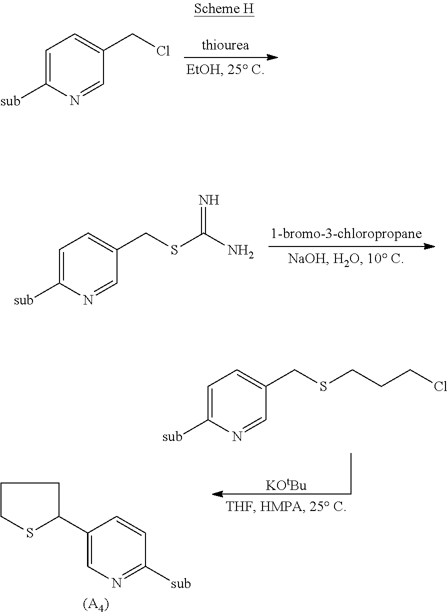

In Scheme I, the sulfide of formula (A₅), wherein R¹ is previously defined, L is a bond, n=0 and Y is 6-chloropyridin-3-yl can be prepared from 2-chloro-5-bromopyridine with a halo-metal exchange followed by a substitution with disulfide.

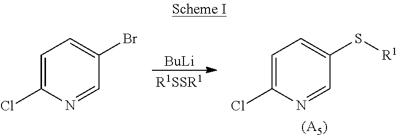

Sulfoximine compounds of type Ib wherein R¹, S and L taken together form a saturated 5- or 6-membered ring and n=1 can be prepared by the methods illustrated in Scheme J wherein X and Y are as previously defined and m is 0 or 1.

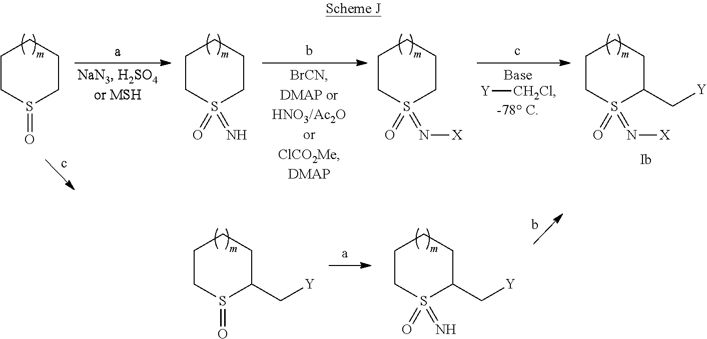

In step a of Scheme J, which is similar to step b of Scheme A, sulfoxide is iminated with sodium azide in the presence of concentrated sulfuric acid or with O-mesitylsulfonylhydroxylamine in a polar aprotic solvent to provide sulfoximine. Chloroform or dichloromethane are the preferred solvents.

In step b of Scheme J, similar to step c of Scheme A, the nitrogen of sulfoximine can be either cyanated with cyanogen bromide, or nitrated with nitric acid followed by treatment with acetic anhydride under refluxing conditions, or carboxylated with methyl chloroformate in the presence of base such as DMAP to provide N-substituted cyclic sulfoximine. Base is required for efficient cyanation and carboxylation and the preferred base is DMAP, whereas sulfuric acid is used as catalyst for efficient nitration reaction.

In step c of Scheme J, the α-carbon of N-substituted sulfoximine can be alkylated with a heteroaromatic methyl halide in the presence of a base such as KHMDS or butyl lithium (BuLi) to give the desired N-substituted sulfoximines. The preferred halide can be bromide, chloride or iodide.

Alternatively, the compounds of formula (Ib) can be prepared by a first α-alkylation of sulfoxides to give α-substituted sulfoxides and then an imination of the sulfoxide followed by N-substitution of the resulting sulfoximine by using the steps c, a and b respectively as described above for Scheme J.

Compounds in which Y represents claimed substituents other than 6-(C₁-C₄)haloalkylpyridin-3-yl and 6-(C₁-C₄)haloalkoxypyridin-3-yl have been disclosed in U.S. Patent Publication No. 2005/0228027, the contents of which were incorporated herein by reference in their entirety above.

In one particular but non-limiting form, the pesticide compositions disclosed herein include a cyanosulfoximine compound according to formula (I), non-limiting examples of which are hereinafter provided. It should be understood that these and other examples provided herein are for illustration purposes and are not to be construed as limiting the invention disclosed in this document to only the embodiments disclosed in these examples.

### Example I

### [(6-Trifluoromethylpyridin-3-yl)methyl](methyl)-oxido-λ⁴-sulfanylidenecyanamide (1)

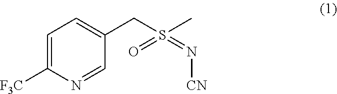 [SMILES: CS(=O)(Cc1ccc(C(F)(F)F)nc1)=NC#N]

[(6-Trifluoromethylpyridin-3-yl)methyl](methyl)-oxido-λ⁴-sulfanylidenecyanamide (1) was prepared from 3-chloromethyl-6-(trifluoromethyl)pyridine according to the following three step sequence:

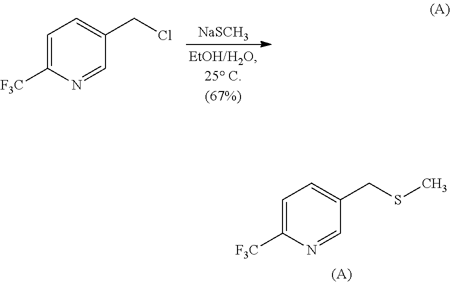

To a solution of 3-chloromethyl-6-(trifluoromethyl)pyridine (5.1 g, 26 mmol) in dimethyl sulfoxide (DMSO; 20 mL) was added in one portion sodium thiomethoxide (1.8 g, 26 mmol). A violent exothermic reaction was observed which resulted in the reaction turning dark. The reaction was stirred for 1 hr, then additional sodium thiomethoxide (0.91 g, 13 mmol) was added slowly. The reaction was stirred overnight, after which it was poured into H₂O and several drops of conc. HCl were added. The mixture was extracted with Et₂O (3×50 mL) and the organic layers combined, washed with brine, dried over MgSO₄ and concentrated. The crude product was purified by chromatography (Prep 500, 10% acetone/hexanes) to furnish the sulfide (A) as a pale yellow oil (3.6 g, 67%). ¹H NMR (300 MHz, CDCl₃): δ 8.6 (s, 1H), 7.9 (d, 1H), 7.7 (d, 1H), 3.7 (s, 2H), 2.0 (s, 3H); GC-MS: mass calcd for C₈H₈F₃NS [M]⁺ 207. Found 207.

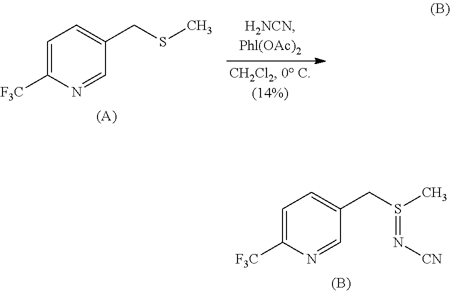

To a solution of sulfide (A) (3.5 g, 17 mmol) and cyanamide (1.4 mg, 34 mmol) in dichloromethane (30 mL) at 0° C. was added iodobenzenediacetate (11.0 g, 34 mmol) all at once. The reaction was stirred for 30 minutes then allowed to warm to room temperature overnight. The mixture was diluted with dichloro-methane (50 mL) and washed with H₂O. The aqueous layer was extracted with ethyl acetate (4×50 mL), and the combined dichloromethane and ethyl acetate layers dried over MgSO₄ and concentrated. The crude product was triturated with hexanes and purified by chromatography (chromatotron, 60% acetone/hexanes) to furnish the sulfilimine (B) as a yellow gum (0.60 g, 14%). IR (film) 3008, 2924, 2143, 1693 cm⁻¹; ¹H NMR (300 MHz, CDCl₃): δ 8.8 (s, 1H), 8.0 (d, 1H), 7.8 (d, 1H), 4.5 (d, 1H), 4.3 (d, 1H), 2.9 (s, 3H); LC-MS (ESI): mass calcd for C₉H₉F₃N₃S [M+H]⁺ 248.04. Found 248.

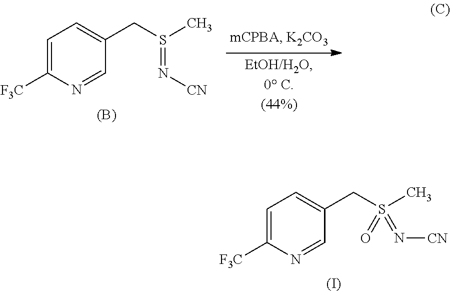

To a solution of m-chloroperbenzoic acid (mCPBA; 80%, 1.0 g, 4.9 mmol) in EtOH (10 mL) at 0° C. was added a solution of K₂CO₃ (1.4 g, 10 mmol) in H₂O (7 mL). The solution was stirred for 20 min and then a solution of sulfilimine (B) (0.60 g, 2.4 mmol) in EtOH (20 mL) was added all at once. The reaction was stirred at 0° C. for 30 min, and then allowed to warm to room temperature over the course of 1 hr. The reaction was quenched with aq. sodium bisulfite and the mixture concentrated to remove ethanol. The resulting mixture was extracted with dichloromethane and the combined organic layers dried over MgSO₄ and concentrated. The crude product was purified by chromatography (chromatotron, 50% acetone/hexanes) to furnish the sulfoximine (1) as an off-white solid (0.28 g, 44%). Mp=135-137° C.; ¹H NMR (300 MHz, CDCl₃): δ 8.8 (s, 1H), 8.1 (d, 1H), 7.8 (d, 1H), 4.7 (m, 2H), 3.2 (s, 3H); LC-MS (ELSD): mass calcd for C₉H₉F₃N₃OS [M+H]⁺ 264.04. Found 263.92.

### Example II

### [1-(6-Trifluoromethylpyridin-3-yl)ethyl](methyl)-oxido-λ⁴-sulfanylidenecyanamide (2)

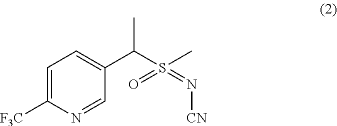 [SMILES: CC(c1ccc(C(F)(F)F)nc1)S(C)(=O)=NC#N]

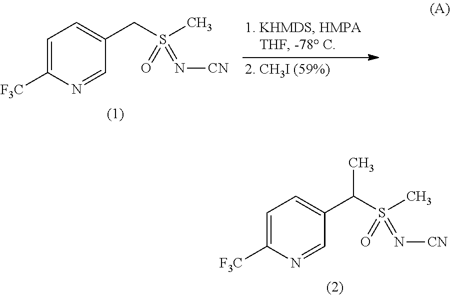

[1-(6-Trifluoromethylpyridin-3-yl)ethyl](methyl)-oxido-λ⁴-sulfanylidenecyanamide (2) was prepared from [(6-trifluoromethylpyridin-3-yl)methyl]-(methyl)-oxido-λ⁴-sulfanylidenecyanamide (1) using the method outlined in Scheme C:

To a solution of sulfoximine (1) (50 mg, 0.19 mmol) and hexamethyl-phosphoramide (HMPA; 17 μL, 0.10 mmol) in tetrahydrofuran (THF; 2 mL) at −78° C. was added potassium hexamethyldisilazane (KHMDS; 0.5 M in toluene, 420 μL, 0.21 mmol) dropwise. The solution was stirred at −78° C. for an additional 20 min, after which iodomethane (13 μL, 0.21 mmol) was added. The reaction was allowed to warm to room temperature over the course of 1 hr, after which it was quenched with saturated aqueous (aq.) NH₄Cl and extracted with dichloro-methane. The organic layer was dried over Na₂SO₄, concentrated, and the crude product purified by chromatography (chromatotron, 70% acetone/CH₂Cl₂) to furnish the sulfoximine (2) as a 2:1 mixture of diastereomers (colorless oil; 31 mg, 59%). Sulfoximine (2) is commonly known as sulfoxaflor, further details of which are available at http://www.alanwood.net/pesticides/index_cn_frame.html. According to a revised version of IUPAC nomenclature, sulfoximine (2) is also referred to as [methyl(oxido){1-[6-(trifluoromethyl)-3-pyridyl]ethyl}-λ⁶-sulfanylidene]cyanamide, and the CAS name given to sulfoximine (2) is N-[methyloxido[1-[6-(trifluoromethyl)-3-pyridinil]ethyl]-λ⁴-sulfanylidene]cyanamide. ¹H NMR (300 MHz, CDCl₃): 8 (major diastereomer) 8.8 (s, 1H), 8.1 (d, 1H), 7.8 (d, 1H), 4.6 (q, 1H), 3.0 (s, 3H), 2.0 (d, 3H); (minor diastereomer) 8.8 (s, 1H), 8.1 (d, 1H), 7.8 (d, 1H), 4.6 (q, 1H), 3.1 (s, 3H), 2.0 (d, 3H); LC-MS (ELSD): mass calcd for C₁₀H₁₀F₃N₃OS [M+H]⁺ 278.06. Found 278.05.

### Example III

### 2-(6-Trifluoromethylpyridin-3-yl)-1-oxido-tetrahydro-1H-1λ⁴-thien-1-ylidenecyanamide (3)

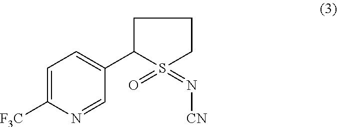 [SMILES: N#CN=S1(=O)CCCC1c1ccc(C(F)(F)F)nc1]

2-(6-Trifluoromethylpyrindin-3-yl)-1-oxido-tetrahydro-1H-1λ⁴-thien-1-ylidenecyanamide (3) was prepared from 3-chloromethyl-6-(trifluoromethyl)-pyridine according to the 5 step sequence outline below:

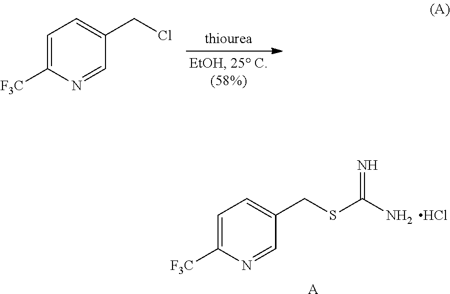

To a suspension of thiourea (1.2 g, 16 mmol) in EtOH (25 mL) was added a solution of 3-chloromethyl-6-(trifluoromethyl)pyridine in EtOH (10 mL). The suspension was stirred at room temperature for 2 days, during which a white precipitated formed. The precipitate was filtered to give the desired amidine hydrochloride as a white solid (2.4 g, 58%). Mp=186-188° C. No further attempt was made to purify the product. ¹H NMR (300 MHz, CDCl₃): δ 8.9 (bs, 4H), 8.4 (s, 1H), 7.6 (d, 1H), 7.3 (d, 1H), 4.2 (s, 2H); LC-MS (ELSD): mass calcd for C₈H₈F₃N₃S [M+H]⁺ 236.05. Found 236.01.

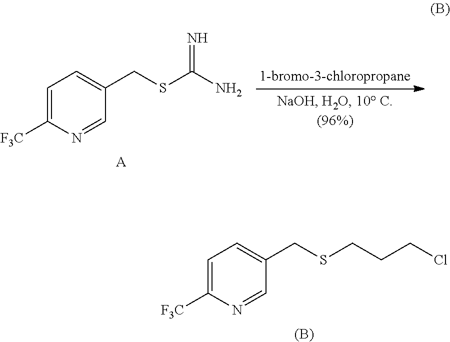

To a solution of amidine hydrochloride (A) (1.8 g, 6.8 mmol) in H₂O (12 mL) at 10° C. was added 10 N NaOH (0.68 mL, 6.8 mmol), which resulted in the formation of a white precipitate. The suspension was heated at 100° C. for 30 min, then cooled back down to 10° C. Additional 10 N NaOH (0.68 mL, 6.8 mmol) was added, followed by 1-bromo-3-chloropropane (0.67 mL, 6.8 mmol) all at once. The reaction was stirred at room temperature overnight, then extracted with dichloromethane. The combined organic layers were washed with brine, dried over Na₂SO₄ and concentrated to furnish the sulfide (B) as a colorless oil (1.7 g, 96%). No further attempt was made to purify the product. ¹H NMR (300 MHz, CDCl₃): δ 8.6 (s, 1H), 7.8 (d, 1H), 7.6 (d, 1H), 3.8 (s, 2H), 3.6 (t, 2H), 2.6 (t, 2H), 2.0 (quint, 2H).

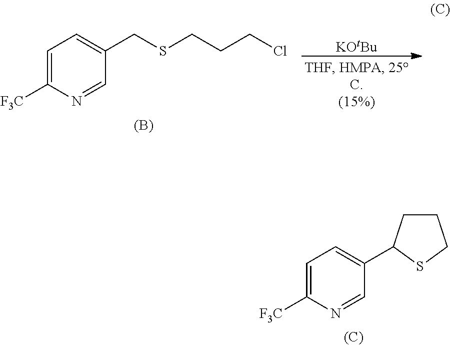

To a suspension of potassium tert-butoxide (1.5 g, 13 mmol) in THF (12 mL) was added HMPA (1.7 mL, 10 mmol) followed by a solution of sulfide (B) (1.8 g, 6.7 mmol) in THF (3 mL) dropwise. The reaction was allowed to stir at room temperature overnight, followed by concentration and purification by chromatography (Biotage, 40% EtOAc/hexanes) to furnish cyclized product (C) as an orange oil (230 mg, 15%). ¹H NMR (300 MHz, CDCl₃): δ 8.7 (s, 1H), 8.0 (d, 1H), 7.6 (d, 1H), 4.6 (dd, 1H), 3.2 (m, 1H), 3.1 (m, 1H), 2.5 (m, 1H), 2.3 (m, 1H), 2.1-1.9 (m, 2H).

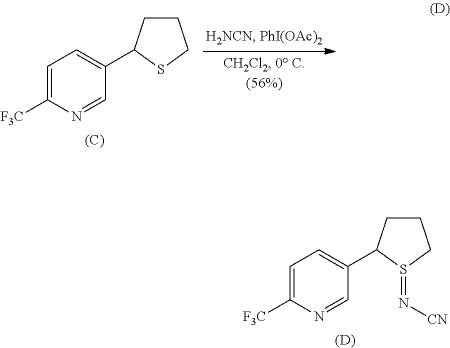

To a solution of sulfide (C) (230 mg, 0.99 mmol) and cyanamide (83 mg, 2.0 mmol) in dichloromethane (5 mL) at 0° C. was added iodobenzenediacetate (350 mg, 1.1 mmol) all at once. The reaction was stirred for 3 hr, then concentrated and the crude product purified by chromatography (chromatotron, 50% acetone/hexanes) to furnish the sulfilimine (D) as an orange oil (150 mg, mixture of diastereomers, 56%). ¹H NMR (300 MHz, CDCl₃): δ 8.8 (s, 1H), 7.9 (d, 1H), 7.8 (d, 1H), 4.8 (dd, 1H), 3.5 (m, 2H), 2.9-2.7 (m, 2H), 2.6 (m, 1H), 2.3 (m, 1H).

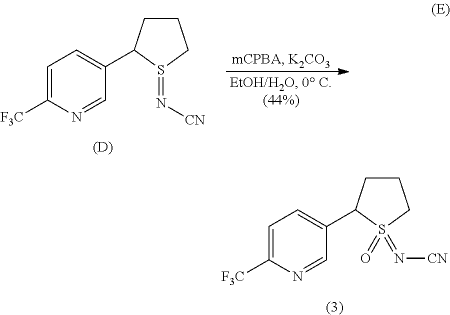

To a solution of mCPBA (80%, 180 mg, 0.82 mmol) in EtOH (3 mL) at 0° C. was added a solution of K₂CO₃ (230 mg, 1.7 mmol) in H₂O (1.5 mL). The solution was stirred for 20 min and then a solution of sulfilimine (D) (150 mg, 0.55 mmol) in EtOH (2 mL) was added all at once. The reaction was stirred at 0° C. for 45 min, after which the solvent was decanted into a separate flask and concentrated to give a white solid. The solid was slurried in CHCl₃, filtered, and concentrated to furnish pure sulfoximine (3) as a colorless oil (72 mg, 44%). ¹H NMR (300 MHz, CDCl₃): δ (1.5:1 mixture of diastereomers) 8.8 (s, 2H), 8.0 (d, 2H), 7.8 (d, 2H), 4.7 (q, 1H), 4.6 (q, 1H), 4.0-3.4 (m, s, 4H), 3.0-2.4 (m, 8H); LC-MS (ELSD): mass calcd for C₁₁H₁₁F₃N₃OS [M+H]⁺ 290.06. Found 289.99.

### Example IV

### [(6-Chloropyridin-3-yl)methyl](methyl)oxido-λ⁴-sulfanylidene-cyanamide (4)

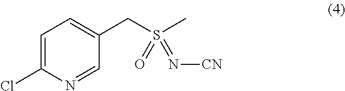

[(6-Chloropyridin-3-yl)methyl](methyl)oxido-λ⁴-sulfanylidenecyanamide (4) was prepared from 3-chloromethyl-6-chloropyridine via the same 3 step sequence outline in Example I. Product was a white solid; mp=115-117° C.; ¹H NMR (300 MHz, CD₃OD/CDCl₃) δ 8.5 (d, 1H), 8.0 (dd, 1H), 7.6 (d, 1H), 5.0 (s, 2H), 3.4 (s, 3H); LC-MS (ELSD): mass calcd for C₈H₉ClN₃OS [M+H]⁺ 230. Found 230.

### Example V

### [1-(6-Chloropyridin-3-yl)ethyl](methyl)oxido-λ⁴-sulfanylidene-cyanamide (5)

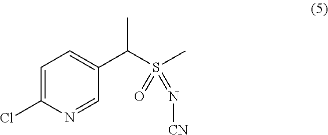

[1-(6-Chloropyridin-3-yl)ethyl](methyl)oxido-λ⁴-sulfanylidenecyanamide (5) was prepared from [(6-chloropyridin-3-yl)methyl](methyl)oxido-λ⁴-sulfanylidenecyanamide (4) via the same protocol as described in Example II. The final product, isolated as a 3:2 mixture of diastereomers, was an off-white solid; mp=155-164° C. LC-MS (ELSD): mass calcd for C₉H₉ClN₃OS [M−H]⁺ 242. Found 242. The diastereomers of (5) could be separated by recrystallization (2:1 MeOH/H₂O) and subsequent chromatotron chromatography of the supernate to provide (6) and (7) (Stereochemistry arbitrarily assigned).

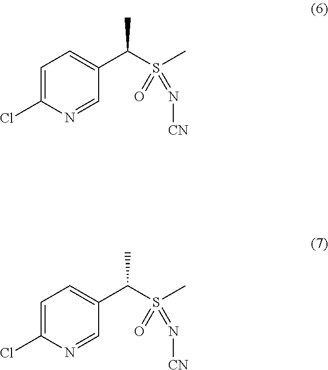

Compound (6) was isolated as a white solid; mp=163-165° C.; ¹H NMR (300 MHz, CDCl₃): δ 8.4 (d, 1H), 7.9 (dd, 1H), 7.5 (d, 1H), 4.6 (q, 1H), 3.1 (s, 3H), 2.0 (d, 3H); LC-MS (ELSD): mass calcd for C₉H₁₁ClN₃OS [M+H]⁺, 244. Found 244.

Compound (7) was isolated as a colorless oil; ¹H NMR (300 MHz, CDCl₃) δ 8.4 (d, 1H), 7.9 (dd, 1H), 7.5 (d, 1H), 4.6 (q, 1H), 3.0 (s, 3H), 2.0 (d, 3H); LC-MS (ELSD): mass calcd for C₉H₁₁ClN₃OS [M+H]⁺, 244. Found 244.

### Example VI

### 2-(6-Chloropyridin-3-yl)-1-oxido-tetrahydro-1H-1-λ⁴-thien-1-ylidenecyanamide (8)

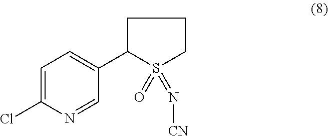 [SMILES: N#CN=S1(=O)CCCC1c1ccc(Cl)nc1]

2-(6-Chloropyridin-3-yl)-1-oxido-tetrahydro-1H-1λ⁴-thien-1-ylidenecyanamide (8) was prepared from 3-chloromethyl-6-chloropyridine according to the same five step sequence described in Example III. Product was a colorless gum and a 1:1 ratio of diastereomers. Diastereomer 1: IR (film) 3439, 3006, 2949, 2194 cm⁻¹; ¹H NMR (300 MHz, CDCl₃): δ 8.4 (d, 1H), 7.8 (dd, 1H), 7.4 (d, 1H), 4.6 (dd, 1H), 3.6 (m, 2H), 2.4-2.7 (m, 4H); GC-MS: mass calcd for C₁₀H₁₁ClN₃OS [M+H]⁺ 256. Found 256. Diastereomer 2: IR (film) 3040, 2926, 2191 cm⁻¹; ¹H NMR (300 MHz, CDCl₃): δ 8.4 (d, 1H), 7.8 (dd, 1H), 7.4 (d, 1H), 4.7 (dd, 1H), 3.8 (ddd, 1H), 3.4 (m, 1H), 2.8 (m, 1H), 2.6 (m, 2H), 2.3 (m, 1H); GC-MS: mass calcd for C₁₀H₁₁ClN₃OS [M+H]⁺ 256. Found 256.

### Example VII

### (1-{6-[chloro(difluoro)methyl]pyridin-3-yl}ethyl)(methyl)-oxido-λ⁴-sulfanylidenecyanamide (9)

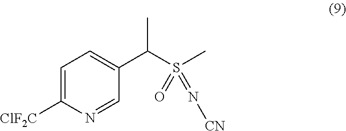

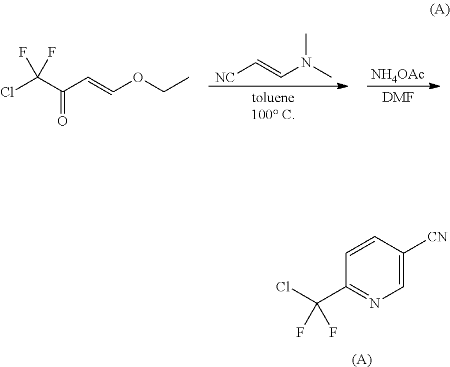

(3E)-1-Chloro-4-ethoxy-1,1-difluorobut-3-en-2-one (7.36 g, 40 mmol) was dissolved in dry toluene (40 mL) and treated with 3-dimethylaminoacrylonitrile (4.61 g, 48 mmol) at room temperature. The solution was heated at about 100° C. for 3.5 hr. The solvent was then removed under reduced pressure and the remaining mixture was re-dissolved in DMF (20 mL), treated with ammonium acetate (4.62 g, 60 mmol) and stirred at room temperature overnight. Water was added to the reaction mixture and the resulting mixture was extracted with ether-CH₂CH₂ (1:2, v/v) twice. The combined organic layer was washed with brine, dried, filtered and concentrated. The residue was purified on silica gel to give 3.1 g of 6-[chloro(difluoro)methyl]nicotinonitrile (A) as light colored oil in 41% yield. GC-MS: mass calcd for C₇H₃ClF₂N₂ [M]⁺ 188. Found 188.

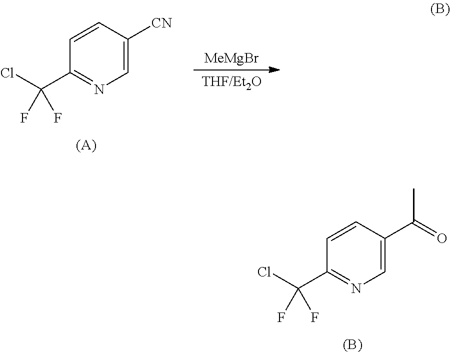

6-[Chloro(difluoro)methyl]nicotinonitrile (A) (3.0 g, 15.8 mmol) was dissolved in anhydrous ether (25 mL) and cooled in an ice-water bath. A solution of 3 M of methylmagnesium bromide in hexane (6.4 mL, 19 mmol) was added through a syringe. After the addition was over, the mixture was stirred at 0° C. for 5 hr and then at room temperature for 10 hr. The reaction was quenched slowly with 1 N citric acid aqueous solution at 0° C. and the resulting mixture was stirred at room temperature for 1 hr. The pH was adjusted back to pH 7 with saturated NaHCO₃ aqueous solution. The two phases were separated and the aqueous phase was extracted with ethyl acetate twice. The combined organic layer was washed with brine, dried over anhydrous Na₂SO₄, filtered, and concentrated. The remaining mixture was purified on silica gel eluted with 15% acetone in hexane to give 0.88 g of the desired product 1-{6-[chloro(difluoro)methyl]pyridin-3-yl}-ethanone (B) as brownish oil in 30% yield. GC-MS: mass calcd for C₈H₆ClF₂NO [M]⁺ 205. Found 205.

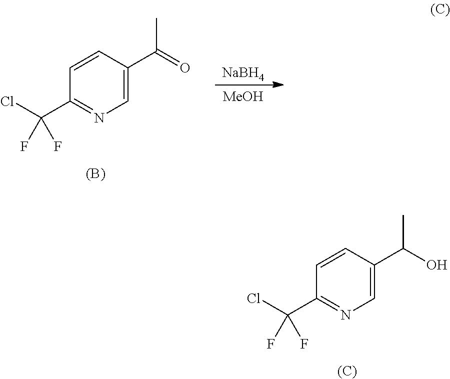

To a solution of 1-{6-[chloro(difluoro)methyl]pyridin-3-yl}ethanone (B) (0.85 g, 4.14 mmol) in MeOH (10 mL) at 0° C. was added NaBH₄ (0.16 g, 4.14 mmol). The mixture was stirred for 30 min and 2 M HCl aqueous solution was added until pH reached 7. Solvent was removed under reduced pressure and the remaining mixture was extracted with CH₂Cl₂ (2×50 mL). The combined organic layer was dried over anhydrous Na₂SO₄, filtered, concentrated, and dried in vacuo to give 0.798 g of analytically pure 1-{6-[chloro(difluoro)methyl]-pyridin-3-yl}ethanol (C) on GC-MS as a light yellow oil in 93% yield. GC-MS: mass calcd for C₈H₆ClF₂NO [M]⁺ 207. Found 207.

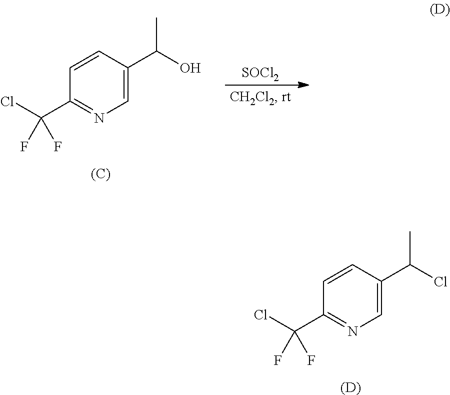

To a solution of 1-{6-[chloro(difluoro)methyl]-pyridin-3-yl}ethanol (0.78 g, 3.77 mmol) in CH₂Cl₂ (40 mL) was added thionyl chloride (0.54 mL, 7.54 mmol) dropwise at room temperature. After 1 hr, the reaction was quenched slowly with saturated NaHCO₃ aqueous solution and the two phases were separated. The organic layer was dried over Na₂SO₄, filtered, concentrated, and dried in vacuum to give 0.83 g of the crude 2-[chloro(difluoro)methyl]-5-(1-chloroethyl)pyridine (D) as brown oil in 98% yield, which was directly used for the next step reaction. GC-MS: mass calcd for C₈H₇Cl₂F₂N [M]⁺ 225. Found 225.

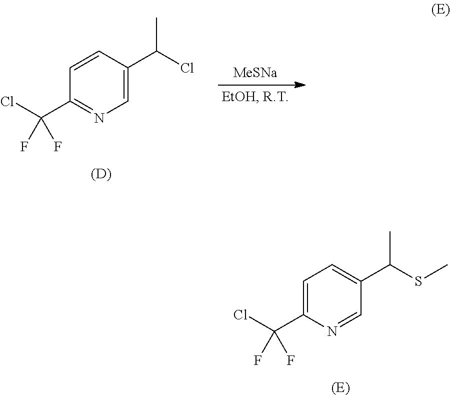

To a solution of 2-[chloro(difluoro)methyl]-5-(1-chloroethyl)pyridine (D) (0.81 g, 3.6 mmol) in ethanol (10 mL) was added sodium thiomethoxide (0.52 g, 7.4 mmol) under stirring in one portion at 0° C. After 10 min, the mixture was allowed to warm to room temperature and stirred overnight. The solvent ethanol was then removed under reduced pressure and the residue was re-taken into ether/CH₂Cl₂ and brine. The two phases were separated and the organic layer was extracted with CH₂Cl₂ one more time. The combined organic layer was dried over anhydrous Na₂SO₄, filtered, concentrated, purified on silica gel using 5% ethyl acetate in hexane to give 0.348 g of the 2-[chloro(difluoro)methyl]-5-[1-(methylthio)ethyl]pyridine (E) in 40% yield GC-MS: mass calcd for C₉H₁₀ClF₂NS [M]⁺ 237. Found 237.

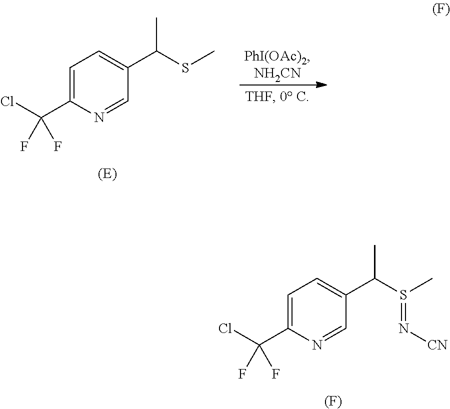

To a stirred solution of 2-[chloro(difluoro)methyl]-5-[1-(methylthio)-ethyl]pyridine (E) (0.32 g, 1.35 mmol) and cyanamide (0.058 g, 1.35 mmol) in THF (7 mL) was added iodobenzene diacetate (0.44 g, 1.35 mmol) in one portion at 0° C. and the resulting mixture was stirred at this temperature for 1 hr and then at room temperature for 2 hr. The solvent was then removed under reduced pressure and the resulting mixture was dissolved in CH₂Cl₂, washed with half-saturated brine, dried over anhydrous Na₂SO₄, filtered, concentrated, and purified on silica gel using 50% acetone in hexane to give 0.175 g of (1-{6-[chloro-(difluoro)methyl]pyridin-3-yl}ethyl)(methyl)-λ⁴-sulfanylidenecyanamide (F) as light-yellow oil in 48% yield. ¹H NMR (300 MHz, CDCl₃) δ 8.71 (d, J=1.8 Hz, 1H), 7.91 (dd, J=8.4, 1.8 Hz, 1H) 7.78 (d, J=8.4 Hz, 1H), 4.42 (q, J=6.9 Hz, 1H), 2.64 (s, 3H), 1.92 (d, J=6.9° Hz, 3H); LC-MS: mass calcd for C₁₀H₁₀ClF₂N₃S [M+1]⁺ 278. Found 278.

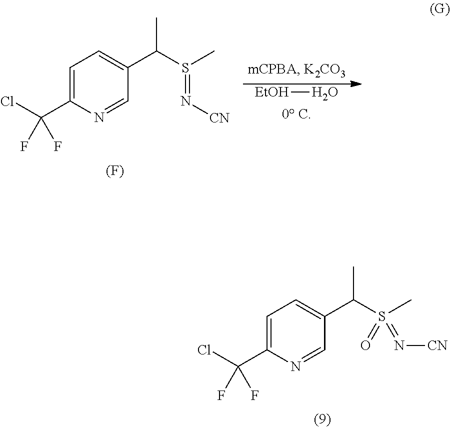

To a stirred solution of (1-{6-[chloro(difluoro)methyl]pyridin-3-yl}ethyl)-(methyl)-λ⁴-sulfanylidenecyanamide (F) (0.16 g, 0.6 mmol) in ethanol (10 mL) was added 20% potassium carbonate aqueous solution (1.24 g, 1.8 mmol) at 0° C. under stirring. After 10 min stirring, 80% mCPBA (0.19 g, ca 0.9 mmol) was added to the mixture, which was stirred at 0° C. for 2 hr after which the reaction was quenched with a spatula of solid sodium thiosulfate. Most of the solvent ethanol was removed under reduced pressure and an aqueous saturated NaHCO₃-brine (1:1, v/v) solution was added and the mixture extracted with chloroform three times. The combined organic layer was dried over Na₂SO₄, filtered and concentrated. The residue was purified on silica gel using 35-50% acetone in hexane as eluent to give 0.092 g of the product (1-{6-[chloro(difluoro)-methyl]pyridin-3-yl}ethyl)(methyl)oxido-λ⁴-sulfanylidenecyanamide (9) as colorless oil in 57% yield. ¹H NMR (300 MHz, CDCl₃) δ 8.79 (s, 1H), 8.09 (d, J=8.1 Hz, 1H), 7.80 (d, J=8.1 Hz, 1H), 4.73 (q, J=7.2 Hz, 1H), 3.16 and 3.11 (2 s, 3H, a mixture of two diastereomeric α-CH₃ groups between the sulfoximine and the pyridine tail), 2.00 (d, J=7.2 Hz, 3H); LC-MS: mass calcd for C₁₀H₁₀ClF₂N₃OS [M−1]⁺ 292. Found 292.

### Example VIII

### [1-(6-trichloromethylpyridin-3-yl)ethyl](methyl)-oxido-λ⁴-sulfanylidenecyanamide (10)

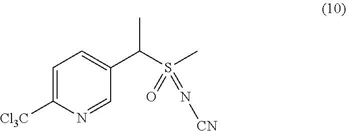

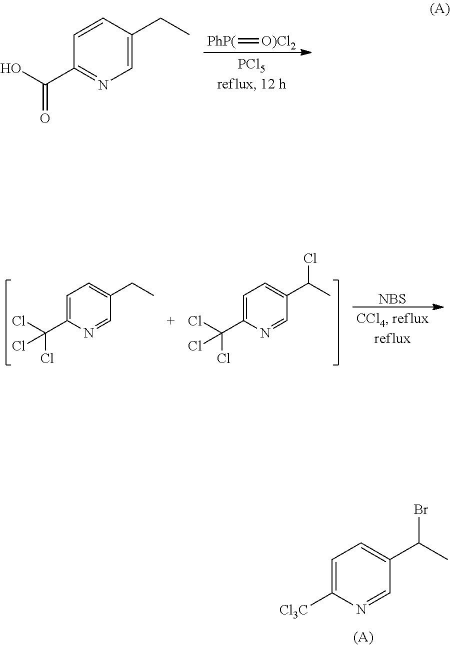

A mixture of 5-ethylpyridine-2-carboxylic acid (1.98 g, 13 mmol), phenyl-phosphonic dichloride (2.8 g, 14.3 mmol), phosphorus pentachloride (7.7 g, 32 mmol) was stirred and slowly heated. Once a clear yellow liquid was formed, the mixture was heated to reflux overnight. After cooling, the volatiles were removed under reduced pressure. The residue was carefully poured into saturated sodium carbonate aqueous solution cooled in an ice-water bath. The aqueous phase was then extracted with CH₂Cl₂ two times. The combined organic layer was washed with brine, dried over anhydrous Na₂SO₄, filtered, concentrated, and partially purified on silica gel eluted with 10% EtOAc in hexane to give 2.7 g of crude product containing both 5-ethyl-2-(trichloromethyl)pyridine and 5-(1-chloro-ethyl)-2-(trichloromethyl)pyridine in an approximate 3:1 ratio (GC data, masses calcd for C₈H₈Cl₃N and C₈H₇Cl₄N [M]⁺ 223 and 257 respectively. Found 223 and 257 respectively).

A mixture of the above-mentioned crude product (2.6 g) in carbon tetrachloride (100 mL) was then treated with 80% of N-bromosuccinimide (1.9 g, 11 mmol) and benzoylperoxide (0.66 g, 0.275 mmol) and then refluxed overnight. The solid was filtered off, the filtrate concentrated and the resulting residue purified on silica gel using 4% EtOAc in hexane to give 1.0 g of the desired product 5-(1-bromoethyl)-2-(trichloromethyl)pyridine (A) as a yellow solid. The combined yield for the two steps was 25%. GC-MS: mass calcd for C₈H₇BrCl₃N [M−1-Cl]⁺ 266. Found 266.

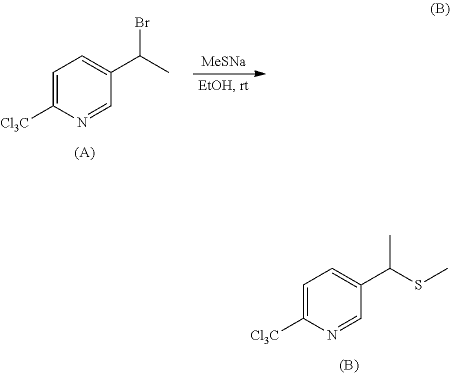

A solution of 5-(1-bromoethyl)-2-(trichloromethyl)pyridine (A) (0.95 g, 3.14 mmol) in ethanol (15 mL) was treated with sodium thiomethoxide (0.44 g, 6.29 mmol) portionwise at 0° C. The mixture was stirred at room temperature overnight. The solvent ethanol was then removed under a reduced pressure and the residue was re-taken into CH₂Cl₂ and brine. The two phases were separated and the organic layer was dried over anhydrous Na₂SO₄, filtered, concentrated. The residue was purified on silica gel using 5% EtOAc in hexane to give 0.57 g of the partially pure 5-[1-(methylthio)ethyl]-2-(trichloromethyl)pyridine (B) in 67% crude yield. GC-MS: mass calcd for C₉H₁₀Cl₃NS [M]⁺ 269. Found 269.

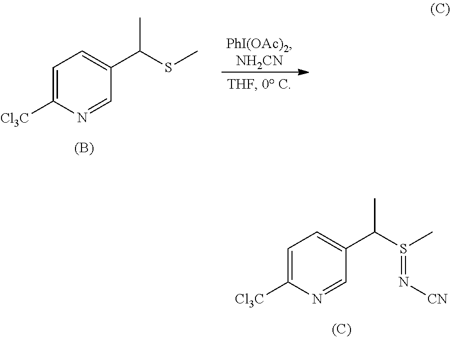

To a stirred solution of 5-[1-(methylthio)ethyl]-2-(trichloromethyl)-pyridine (B) (0.55 g, 2.3 mmol) and cyanamide (0.097 g, 2.3 mmol) in THF (7 mL) cooled to 0° C. was added iodobenzene diacetate (0.75 g, 2.3 mmol) in one portion. The resulting mixture was stirred at 0° C. for 1 hr and then at room temperature for 2 hr. The solvent was removed in vacuo and the resulting mixture was purified on silica gel using 50% acetone in hexane to give 0.254 g of (1E)-methyl{1-[6-(trichloromethyl)pyridin-3-yl]ethyl}-λ⁴-sulfanylidenecyanamide (C) as an off-white solid in 40% yield. ¹H NMR for the diastereomeric mixture (300 MHz, d₆-acetone) δ 8.87 (s, 1H), 8.21-8.25 (m, 2H), 4.65-4.76 (m, 1H), 2.86-2.66 (m, 3H), 1.88-1.92 (m, 3H).

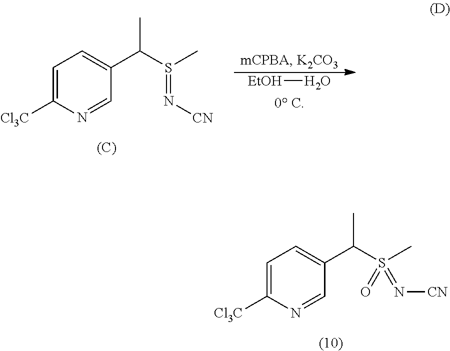

To a stirred solution of (1E)-methyl{1-[6-(trichloromethyl)pyridin-3-yl]ethyl}-λ¹-sulfanylidenecyanamide (C) (0.20 g, 0.65 mmol) in ethanol (15 mL) was added 20% aqueous potassium carbonate solution (1.3 mL) at 0° C., followed by addition of 80% mCPBA. The resulting mixture was stirred for 2 hr at 0° C. and then quenched with solid sodium thiosulfate. Most of the solvent was evaporated and 1:1 aqueous saturated NaHCO₃-brine (v/v) was added and the mixture was extracted with chloroform three times. The combined organic layer was dried over anhydrous Na₂SO₄, filtered and concentrated. The residue was purified on silica gel using 40% acetone in hexane to give 0.10 g of [1-(6-trichloromethylpyridin-3-yl)ethyl](methyl)-oxido-λ⁴-sulfanylidene-cyanamide (10) as colorless oil in 50% yield. ¹H NMR (300 MHz, CDCl₃) δ 8.83 (s, 1H), 8.12-8.23 (m, 1H), 5.15 (q, 1H), 3.37 and 3.28 (2 s, 3H, a mixture of two diastereomeric α-CH₃ groups between the sulfoximine and the pyridine tail), 2.03 (d, 3H); LC-MS: mass calcd for C₁₀H₁₂Cl₃N₃OS [M+1]⁺ 328. Found 328.

### Example IX

### [(6-difluoromethylpyridin-3-yl)methyl](methyl)-oxido-λ⁴-sulfanylidenecyanamide (11)

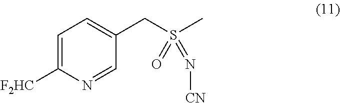 [SMILES: CS(=O)(Cc1ccc(C(F)F)nc1)=NC#N]

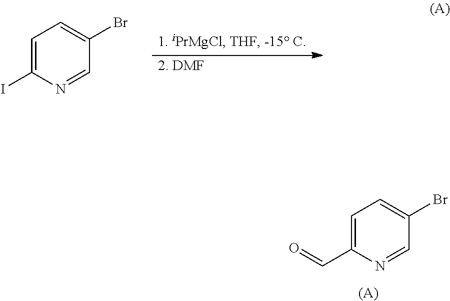

To a solution of 2-iodo-5-bromopyridine (18.4 g, 65 mmol) in THF (100 mL) at −15° C. was added isopropylmagnesium chloride (2M, 35 mL, 70 mmol) dropwise at a rate such that the temperature of the reaction did not exceed 0° C. The reaction was stirred at −15° C. for 1 h, then DMF (7.5 mL, 97 mmol) was added dropwise at a rate such that the temperature of the reaction did not exceed 0° C. The reaction was stirred for 30 min, then warmed to room temperature for an additional 1 h. The reaction was cooled back down to 0° C. and 2 N HCl (80 mL) was added dropwise, maintaining the temperature below 20° C. After stirring for 30 min, 2 N NaOH was added until pH 7 was reached. The organic layer was then separated and the aqueous layer extracted with CH₂Cl₂ (3×). The combined organic layers were dried over MgSO₄, concentrated and purified by flash chromatography (SiO₂, 10% EtOAc/hexanes) to furnish 5-bromopyridine-2-carbaldehyde (A) as a white solid (7.3 g, 60%). ¹H NMR (300 MHz, CDCl₃) δ 10.0 (s, 1H), 8.9 (s, 1H), 8.0 (d, 1H), 7.8 (d, 1H).

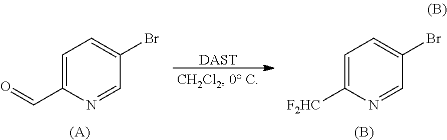

To a cooled solution of 5-bromopyridine-2-carbaldehyde (A) (7.0 g, 38 mmol) in CH₂Cl₂ (300 mL) at −78° C. was added diethylaminosulfur trifluoride (DAST, 10.8 mL, 83 mmol). The reaction was allowed to warm to room temperature over the course of 6 h, then it was quenched slowly with H₂O, washed with saturated aqueous NaHCO₃ and dried over Na₂SO₄. Concentration and purification by silica gel plug (CH₂Cl₂ eluent) furnished 5-bromo-2-difluoromethylpyridine (B) as brown crystals (5.3 g, 67%). ¹H NMR (300 MHz, CDCl₃) δ 8.8 (s, 1H), 8.0 (d, 1H), 7.6 (d, 1H), 6.6 (t, 1H).

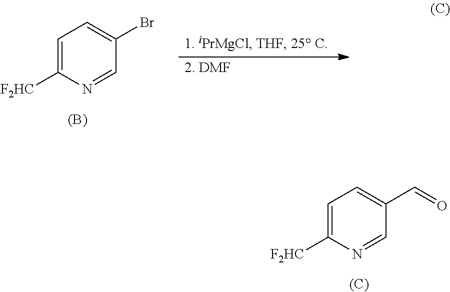

To a solution of 5-bromo-2-difluoromethylpyridine (B) (1.8 g, 8.6 mmol) in THF (40 mL) at 25° C. was added isopropylmagnesium chloride (2M, 8.6 mL, 17 mmol) dropwise. The reaction was allowed to stir for 2 h, then DMF (660 μL, 8.6 mmol) was added and the reaction was stirred for an additional 22 h. The reaction was quenched with 2M HCl and basified with 1M NaOH until pH 7 reached. The organic layer was separated and the aqueous layer was extracted with CH₂Cl₂. The combined organic layers were dried over Na₂SO₄, concentrated and purified by flash chromatography (10% EtOAc/hexanes) to furnish 6-difluoromethylpyridine-3-carbaldehyde (C) as an orange oil (320 mg, 24%).

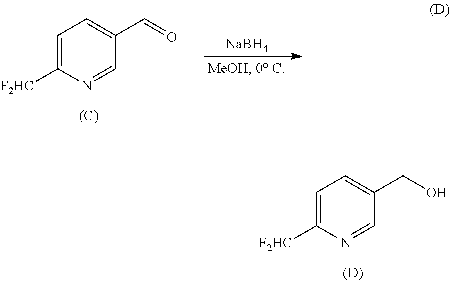

To a solution of 6-difluoromethylpyridine-3-carbaldehyde (C) (500 mg, 3.2 mmol) in MeOH (10 mL) at 0° C. was added NaBH₄ (60 mg, 1.6 mmol). The reaction was allowed to stir for 30 min, then 2M HCl was added until pH 2 was reached. The resulting solution was extracted with CH₂Cl₂ (3×) and the combined organic layers dried over Na₂SO₄ and concentrated to furnish (6-difluoromethyl-pyridin-3-yl)methanol (D) as an orange oil (420 mg, 82%) which was used in the next step without further purification. ¹H NMR (300 MHz, CDCl₃) δ 8.6 (s, 1H), 7.9 (d, 1H), 7.6 (d, 1H), 6.6 (t, 1H), 4.8 (s, 2H).

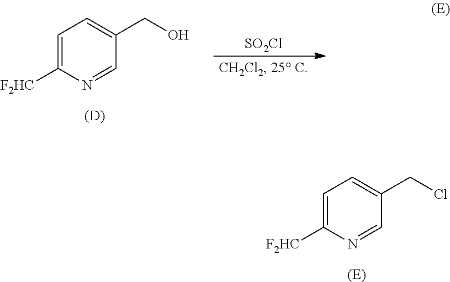

To a solution of (6-difluoromethylpyridin-3-yl)methanol (D) (450 mg, 2.8 mmol) in CH₂Cl₂ (10 mL) at room temperature was SOCl₂ (230 μL, 3.1 mmol). The reaction was allowed to stir for 1 h, then the reaction was quenched slowly with saturated aqueous NaHCO₃. The aqueous phase was extracted with CH₂Cl₂ (3×) and the combined organic layers were dried over Na₂SO₄ and concentrated to furnish the The resulting solution was extracted with CH₂Cl₂ (3×) and the combined organic layers dried over Na₂SO₄ and concentrated to furnish 5-chloromethyl-2-difluoromethylpyridine (E) as a reddish brown oil (490 mg, 98%) which was used in the next step without further purification. ¹H NMR (300 MHz, CDCl₃) δ 8.7 (s, 1H), 7.9 (d, 1H), 7.6 (d, 1H), 6.6 (t, 1H), 4.6 (s, 2H).

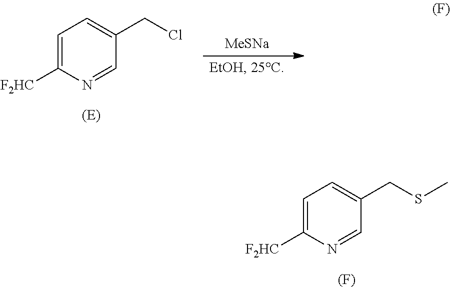

To a solution of sodium thiomethoxide (240 mg, 3.3 mmol) in EtOH (10 ml) at room temperature was added a solution of 5-chloromethyl-2-difluoromethylpyridine (E) (490 mg, 2.8 mmol) in EtOH (3 mL). The reaction was allowed to stir for 9 h, then the reaction was concentrated, taken up in Et₂O, and washed with H₂O. The organic phase was dried over Na₂SO₄ and concentrated to furnish 2-difluoromethyl-5-methylthiomethyl-pyridine (F) as an orange oil (422 mg, 81%) which was used in the next step without further purification. ¹H NMR (300 MHz, CDCl₃) δ 8.6 (s, 1H), 7.8 (d, 1H), 7.6 (d, 1H), 6.6 (t, 1H), 3.7 (s, 2H), 2.0 (s, 3H).

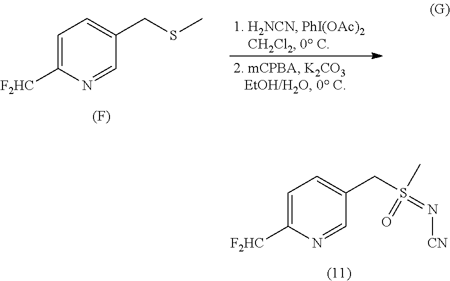

[(6-Difluoromethylpyridin-3-yl)methyl](methyl)-oxido-λ⁴-sulfanylidenecyanamide (11) was synthesized from 2-difluoromethyl-5-methylthiomethylpyridine (F) in two steps as described in Examples I-B and I-C. Isolated as a white solid (51% yield). ¹H NMR (300 MHz, CDCl₃) δ 8.7 (s, 1H), 8.0 (d, 1H), 7.8 (d, 1H), 6.7 (t, 1H), 4.7 (dd, 2H), 3.2 (s, 3H); LC-MS (ELSD): mass calcd for C₉H₁₀F₂N₃OS [M+H]⁺, 246. Found 246.

### Example X

### [1-(6-difluoromethylpyridin-3-yl)ethyl](methyl)-oxido-λ⁴-sulfanylidenecyanamide (12)

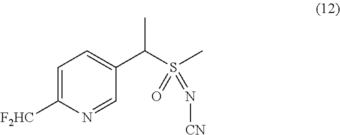 [SMILES: CC(c1ccc(C(F)F)nc1)S(C)(=O)=NC#N]

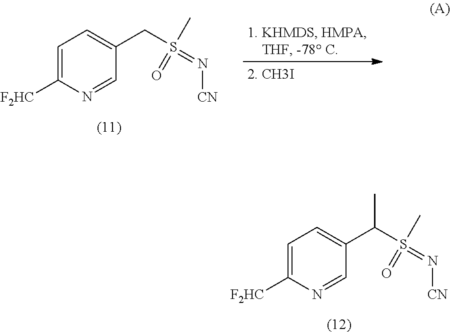

[1-(6-difluoromethylpyridin-3-yl)ethyl](methyl)-oxido-λ⁴-sulfanylidenecyanamide (12) was synthesized from [(6-difluoromethylpyridin-3-yl)methyl](methyl)-oxido-λ⁴-sulfanylidenecyanamide (11) in one step as described in Example II. Isolated as a colorless oil (74% yield) and a 1:1 mixture of diastereomers. ¹H NMR (300 MHz, CDCl₃) 6 (mixture of two diastereomers) 8.7 (s, 2H), 8.0 (d, 2H), 7.8 (d, 2H), 6.7 (t, 2H), 4.6 (q, 2H), 3.1 (s, 3H), 3.0 (s, 3H), 2.0 (d, 6H); LC-MS (ELSD): mass calcd for C₁₀H₁₂F₂N₃OS [M+H]⁺, 260. Found 260.

### Example XI

### [1-(6-pentafluoroethylpyridin-3-yl)ethyl](methyl)-oxido-λ⁴-sulfanylidenecyanamide (13)

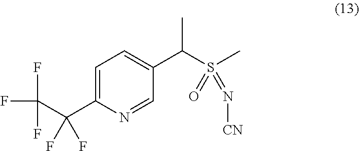 [SMILES: CC(c1ccc(C(F)(F)C(F)(F)F)nc1)S(C)(=O)=NC#N]

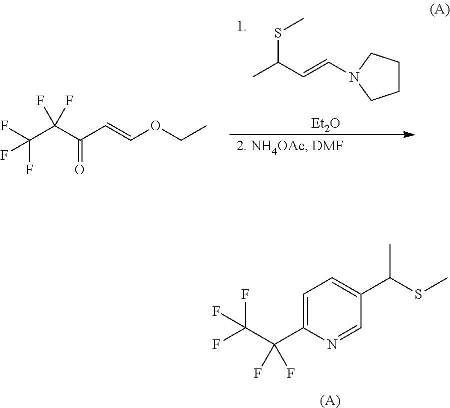 [SMILES: "Et2O" ; CCO/C=C/C(=O)C(F)(F)C(F)(F)F ; CSC(C)/C=C/N1CCCC1 ; CSC(C)c1ccc(C(F)(F)C(F)(F)F)nc1 ; "(A)"]

(E)-1-Ethoxy-4,4,5,5,5-pentafluoropent-1-en-3-one (1.09 g, 5 mmol) in anhydrous ethyl ether (5 mL) was treated with 1-((E)-3-methylthiobut-1-enyl)pyrrolidine (0.85 g, 5 mmol) in 2 mL dry ether at −15° C. over a period of 5 min and the reaction was continued for 20 min. Then the temperature was allowed to rise to room temperature and the reaction continued for 3 h. The solvent was removed under reduced pressure and the residue re-dissolved in anhydrous DMF (5 mL). Ammonium acetate (0.58 g, 7.5 mmol) was added and the mixture stirred at room temperature over a weekend. Water was added and mixture extracted with ether three times. The combined organic layer was washed with brine, dried over anhydrous Na₂SO₄, filtered, concentrated, and purified on silica gel eluted with 8% EtOAc in hexane (v/v) to give 0.16 g of the desired 5-(1-methylthioethyl)-2-pentafluoroethylpyridine (A) as brownish colored oil in 12% yield. GC-MS: mass calcd for C₁₀H₁₁F₂N₃S [M]⁺ 271. Found 271.

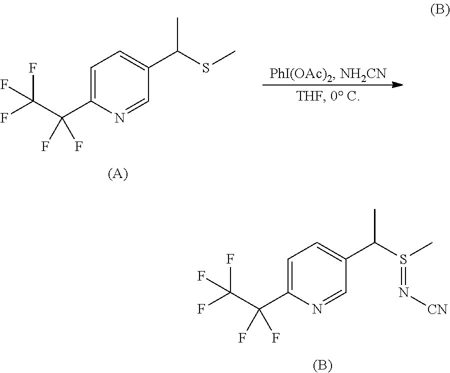

To a stirred solution of the 5-(1-methylthioethyl)-2-pentafluoro-ethylpyridine (A) (0.16 g, 0.6 mmol) and cyanamide (0.025 g, 0.6 mmol) in THF (3 mL) cooled to 0° C. was added iodobenzene diacetate (0.19 g, 0.6 mmol) in one portion and the resulting mixture was stirred at 0° C. for 2 h and then at room temperature overnight. The solvent was removed in vacuo and the resulting mixture was suspended in brine-saturated NaHCO₃ (9:1), which was then extracted with CH₂Cl₂-EtOAc (1:1, v/v) two times. The combined organic layer was dried over Na₂SO₄, filtered, concentrated, and dried to give 0.16 g of (1-{6-[pentafluoroethyl]pyridin-3-yl}ethyl)(methyl)-λ⁴-sulfanylidenecyanamide (B) as a brownish oil in 85% yield. LC-MS: mass calcd for C₁₁H₁₀F₅N₃S [M]⁺ 311.28. Found [M−1]⁺ 309.84

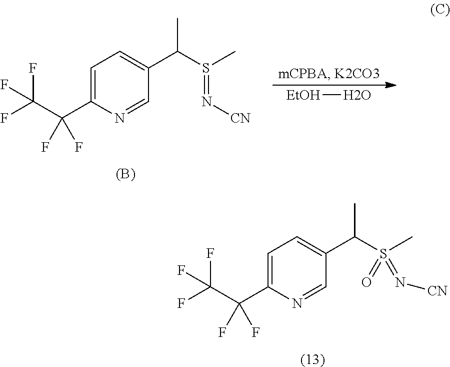

To a stirred solution of the 80% 3-chloroperoxybenzoic acid (0.17 g, ca 0.8 mmol) in ethanol (3 mL) cooled to 0° C. was added 20% aqueous potassium carbonate (1.0 mL, 1.5 mmol and the resulting mixture was stirred at 0° C. for 20 min. Then (1-{6-[pentafluoroethyl]pyridin-3-yl}ethyl)(methyl)-λ⁴-sulfanylidenecyanamide (B) was added at once and the mixture was stirred at 0° C. for 1 h. The reaction was quenched with a small spatula of solid sodium thiosulfate. Most of the solvent was evaporated and brine solution was added and the mixture extracted with CH₂Cl₂ three times. The combined organic layer was dried over Na₂SO₄, filtered and concentrated and the residue was purified on silica gel using 10% acetone in CH₂Cl₂ (v/v) to give 0.089 g of [1-(6-pentafluoroethylpyridin-3-yl)ethyl](methyl)-oxido-λ⁴-sulfanylidenecyanamide (13) as a white solid in 54% yield. LC-MS: mass calcd for C₁₀H₁₀F₅N₃OS [M]⁺ 327.28. Found [M−1]⁺ 325.83.

### Example XII

### [6-(1,1-difluoroethyl)pyridin-3-yl)ethyl](methyl)-oxido-λ⁴-sulfanylidenecyanamide (14)

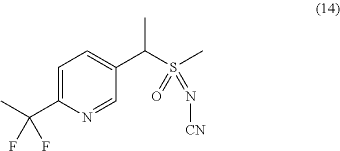 [SMILES: CC(c1ccc(C(C)(F)F)nc1)S(C)(=O)=NC#N]

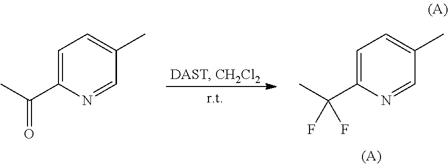

To a solution 5-methyl-2-acetylpyridine (9.9 g, 73.3 mmol) in molecule sieves-dried CH₂Cl₂ (150 mL) was added diethylamino sulfolnyltrifluoride (DAST) (25.8 g, 260 mmol) at room temperature and the mixture was stirred at room temperature overnight. More DAST (12 g, 74 mmol) was added and the reaction continued for two more days after which an additional DAST (3.8 g, 23 mmol) was added and the reaction continued for another 3 days. After the reaction was quenched slowly with saturated NaHCO₃ at 0° C., the organic phase was separated, dried over Na₂SO₄, filtered, and concentrated. The residue was purified on silica gel eluted with 8% EtOAc in hexane to give 3.91 g of 2-(1,1-difluoroethyl)-5-methylpyridine (A) as a light brownish oil in 34% yield. GC-MS: mass calcd for C₈H₉F₂N [M]⁺ 157. Found 157.

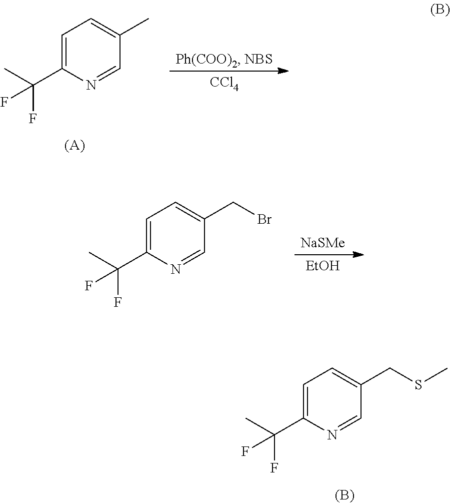

A mixture of 2-(1,1-difluoroethyl)-5-methylpyridine (A) (2.0 g, 12.7 mmol), N-bromosuccinimide (2.2 g, 12.7 mmol) and benzoylperoxide (0.15 g, 0.63 mmol) in carbon tetrachloride (100 mL) was refluxed overnight. After the solid was removed by filtration, the filtrate was concentrated. The residue was re-dissolved in ethanol (40 mL) and sodium thiomethoxide (1.33 g, 19 mmol) was added at room temperature and stirred for 3 h. The solvent was removed under reduced pressure and the remaining mixture was dissolved in CH₂Cl₂ and water. After separation, the organic layer was dried over Na₂SO₄, filtered and concentrated. The crude product 2-(1,1-difluoroethyl)-5-methylthiomethyl-pyridine (B) was 94% pure on GC/MS, which was used directly for the next reaction without further purification. GC-MS: mass calcd for C₉H₁₁F₂NS [M]⁺ 203. Found 203.

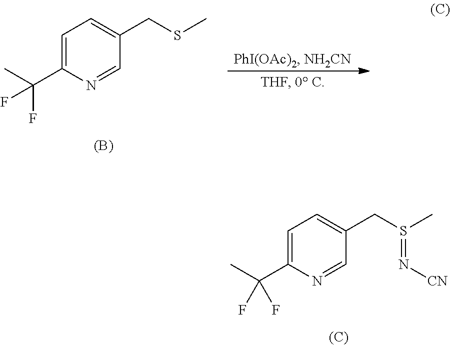 [SMILES: CSCc1ccc(C(C)(F)F)nc1 ; "THF, 0° C." ; "(B)" ; C/S(Cc1ccc(C(C)(F)F)nc1)=N\C#N ; "(C)"]

To a stirred solution of 2-(1,1-difluoroethyl)-5-methylthiomethylpyridine (B) (1.22 g. 6.0 mmol) and cyanamide (0.25 g, 6.0 mmol) in THF (7 mL) cooled to 0° C. was added iodobenzene diacetate (1.93 g, 6.0 mmol) in one portion and the resulting mixture was stirred at 0° C. for 1 h and then at room temperature for 2 h. The solvent was removed in vacuo and the resulting mixture was purified on silica gel using 60% acetone in hexane (v/v) to give 1.22 g of [(6-(1,1-difluoroethylpyridin-3-yl)methyl](methyl)-λ⁴-sulfanylidenecyanamide (C) (84% yield) as brownish oil which turned into a brownish solid after standing in the refrigerator overnight. LC-MS: mass calcd for C₁₀H₁₁F₂N₃S [M]⁺ 243.28. Found [M+1]⁺ 244.11.

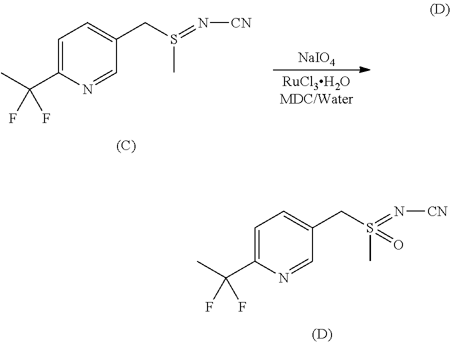

To a 100 ml round bottom flask equipped with magnetic stirrer, addition funnel, and thermometer was charged the sodium periodate (0.95 g, 4.44 mmol) and water (12 mL). After the solid had dissolved, 15 mL of CH₂Cl₂ was added followed by the ruthenium trichloride hydrate (0.033 g, 0.15 mmol). [(6-(1,1-difluoroethylpyridin-3-yl)methyl](methyl)-λ⁴-sulfanylidenecyanamide (C) (0.72 g, 2.96 mmol) dissolved in 5 mL of CH₂Cl₂ was added dropwise over a period of 30 min. The mixture was stirred rapidly at room temperature for 1.5 h and then filtered through a filtering paper to remove some insolubles. The mixture was then separated in separation funnel after ethyl acetate was added to facilitate the separation. The aqueous phase was extracted with CH₂Cl₂ twice. The combined organics was washed with brine, dried over dry Na₂SO₄, filtered, concentrated, and briefly purified on silica gel with 70% acetone in hexane to give 0.652 g of the desired product [(6-(1,1-difluoroethylpyridin-3-yl)methyl](methyl)-oxido-λ⁴-sulfanylidenecyanamide (D) as a white solid in 87% yield. LC-MS: mass calcd for C₁₀H₁₁F₂N₃OS [M]⁺ 259.28. Found [M+1]⁺ 260.02.

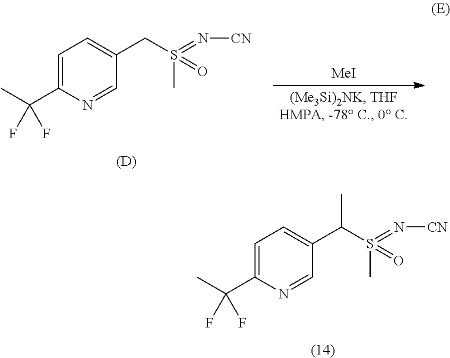 [SMILES: "MeI" ; CC(F)(F)c1ccc(CS(C)(=O)=NC#N)cn1 ; "(Me3Si)2NK, THFHMPA, -78° C., 0° C." ; "(D)" ; CC(c1ccc(C(C)(F)F)nc1)S(C)(=O)=NC#N ; "(14)"]

To a solution of [(6-(1,1-difluoroethylpyridin-3-yl)methyl](methyl)-oxido λ⁴-sulfanylidenecyanamide (D) (0.55 g, 2.0 mmol) and HMPA (0.09 mL, 0.55 mmol) in 20 mL anhydrous THF was added 0.5 M potassium bis(trimethylsilyl)amide in toluene (4.4 mL, 2.2 mmol) at −78° C. dropwise. After 45 min, iodomethane (0.14 mL, 2.2 mmol) was added in one portion via a syringe. Ten minutes later, the temperature was allowed to rise to 0° C. and mixture continued to stir for 1.5 h. The reaction was quenched with saturated aqueous NH₄Cl, diluted with brine, extracted once each with EtOAc and CH₂Cl₂. The combined organic layer was dried over Na₂SO₄, filtered, and concentrated. The residue was purified by preparative HPLC to give 0.15 g of the desired [6-(1,1-difluoroethyl)pyridin-3-yl)ethyl](methyl)-oxido-λ⁴-sulfanylidenecyanamide (14) in 26% yield. LC-MS: mass calcd for C₁₁H₁₃F₂N₃OS [M]⁺ 273.31. Found [M+1]⁺ 274.21.

### Example XIII

### Preparation of [2-(6-trifluoromethylpyridin-3-yl)ethyl](methyl)-oxido-λ⁴-sulfanylidenecyanamide (15)

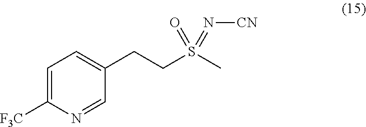 [SMILES: CS(=O)(CCc1ccc(C(F)(F)F)nc1)=NC#N]

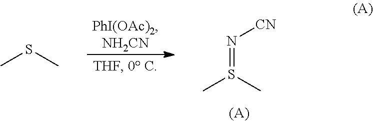

To a solution of dimethylsulfide (10.0 g, 161 mmol) and cyanamide (6.7 g, 161 mmol) in THF (500 mL) at 0° C. was added iodobenzenediacetate (51.8 g, 161 mmol) all at once. Let stir at 0° C. for 30 min, then allowed reaction to warm to room temperature overnight. The reaction was concentrated and purified by passing through a silica gel plug, first with 100% hexanes, then with 100% acetone, furnishing sulfilimine (A) as a colorless oil=13.4 g (82%). NMR (300 MHz, CDCl₃) δ 2.8 (s, 6H); GC-MS: mass calcd for C₃H₆N₂S [M]⁺, 102. Found 102.

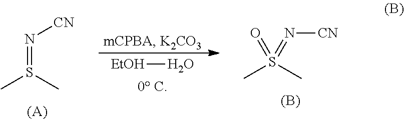

To a solution mCPBA (80%, 25.3 g, 147 mmol) in EtOH (450 mL) at 0° C. was added solution of K₂CO₃ (40.6 g, 294 mmol) in H₂O (340 mL). After 20 min, sulfilimine (10.0 g, 98 mmol) in EtOH (150 mL) was added all at once. The suspension was stirred at 0° C. for 90 min, after which the crude reaction mixture was concentrated to remove EtOH, then extracted with CH₂Cl₂ (3×). The combined organic layers were washed with satd aq NaHCO₃ soln (3×), dried over Na₂SO₄ and concentrated to furnish sulfoximine (B) as a yellow solid=1.310 g (10%). ¹H NMR (300 MHz, CDCl₃) δ 3.4 (s, 6H); GC-MS: mass calcd for C₃H₆N₂OS [M]⁺, 118. Found 118.

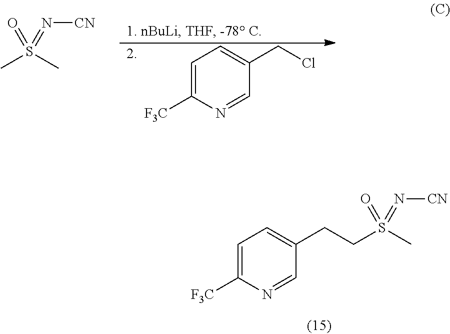

To a solution of sulfoximine (100 mg, 0.85 mmol) in THF (2 mL) at −78° C. was added nBuLi (2.5 M, 340 μL, 0.85 mmol) dropwise. The solution was let solution stir for 20 min, then 5-(chloromethyl)-2-trifluoromethylpyridine (170 mg, 0.85 mmol) was added. The solution was let solution stir at −78° C. for additional 2 h, then quenched with satd aq ammonium chloride and extracted with CH₂Cl₂. The combined organic extracts were dried over sodium sulfate, concentrated and purified by flash chromatography (40% EtOAc/80% hexanes) to furnish [2-(6-trifluoromethylpyridin-3-yl)ethyl](methyl)-oxido-λ⁴-sulfanylidene-cyanamide (15) as a yellow solid=14.5 mg (6%); mp=83-87° C. ¹H NMR (300 MHz, CDCl₃) δ 8.69 (d, 1H), 7.85 (dd, 1H), 7.74 (d, 1H), 3.58-3.79 (m, 2H), 3.38-3.46 (m, 2H), 3.30 (s, 3H); LC-MS (ELSD): mass calcd for C₁₀H₁₁F₃N₃OS [M+H]⁺, 278. Found 278.

### Example XIV

### 2-[(6-trifluoromethylpyridin-3-yl)methyl]-1-oxidotetrahydro-1H-1λ⁴-thien-1-ylidenecyanamide (16)

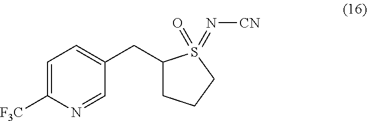 [SMILES: N#CN=S1(=O)CCCC1Cc1ccc(C(F)(F)F)nc1]

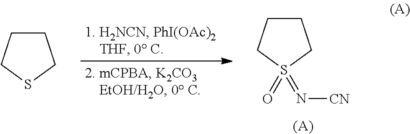

1-Oxidotetrahydro-1H-1λ⁴-thien-1-ylidenecyanamide (A) was prepared from tetrahydrothiophene by a two step procedure as described in Examples VI-A and VI-B (69% yield). ¹H NMR (300 MHz, CDCl₃) δ 3.5 (m, 2H), 3.3 (m, 2H), 2.3-2.5 (m, 4H); GC-MS: mass calcd for C₅H₈N₂OS [M+H]⁺, 144. Found 144.

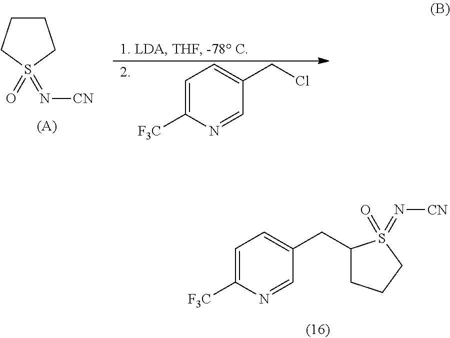

To a solution of 1-oxidotetrahydro-1H-1λ⁴-thien-1-ylidenecyanamide (A) (200 mg, 1.4 mmol) in THF (10 ml) at −78° C. was added LDA solution in THF (1.8M, 850 μL, 1.5 mmol). The reaction was allowed to stir for 45 min, then 5-chloromethyl-2-trifluoromethylpyridine (300 mg, 1.5 mmol) was added dropwise. The solution was allowed to stir at −78° C. for 1 h, then it was warmed to 0° C. for an additional 2 h. The reaction was then quenched with saturated aqueous NH₄Cl and extracted with CH₂Cl₂. The combined organic layers were dried over Na₂SO₄, concentrated, and purified by flash chromatography to furnish 2-[(6-trifluoromethylpyridin-3-yl)methyl]-1-oxidotetrahydro-1H-1λ⁴-thien-1-ylidenecyanamide (16) as a yellow oil (41 mg, 9%). IR (film) 2946, 2194, 1339 cm⁻¹, ¹H NMR (300 MHz, CDCl₃) S (mixture of two diastereomers) 8.6 (s, 2H), 7.8 (m, 2H), 7.7 (d, 1H), 7.6 (d, 1H), 3.4-3.8 (m, 7H), 3.3 (m, 1H), 3.0-3.2 (m, 2H), 1.9-2.6 (m, 8H); LC-MS (ELSD): mass calcd for C₁₂H₁₃F₃N₃OS [M+H]⁺, 304. Found 304.

Further details regarding one or more of the foregoing examples are provided in U.S. Patent Publication No. 2007/0203191, the contents of which are incorporated herein by reference in their entirety.

As indicated above, the pesticide compositions disclosed herein include a herbicide with which a pesticide compound according to formula (I) is synergistic. In particular but non-limiting forms, the herbicide is an organophosphorus herbicide, non-limiting examples of which include amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin. For further details, please see http://www.alanwood.net/pesticides/class_herbicides.html. In one non-limiting form, the herbicide is glufosinate. In another non-limiting form, the herbicide is glyphosate. It is also contemplated that mixtures of one or more of the foregoing organophosphorus herbicides could be included in the pesticide compositions disclosed herein. The pesticide compound according to formula (I) and the herbicide are generally present in the pesticide compositions disclosed herein in synergistically effective amounts. In one form, the ratio by weight between the herbicide or a formulation including the herbicide and the pesticide is in the range of 0.2:1 to 9200:1. In another form, the ratio by weight between the herbicide or a formulation including the herbicide and the pesticide is in the range of 2:1 to 920:1. In yet another form, the ratio by weight between the herbicide or a formulation including the herbicide and the pesticide is in the range of 5:1 to 400:1. In still another form, the ratio by weight between the herbicide or a formulation including the herbicide and the pesticide is in the range of 5:1 to 400:1. In another form, the ratio by weight between the herbicide or a formulation including the herbicide and the pesticide is in the range of 10:1 to 200:1. In yet another form, the ratio by weight between the herbicide or a formulation including the herbicide and the pesticide is in the range of 5:1 to 40:1. In still another form, the ratio by weight between the herbicide or a formulation including the herbicide and the pesticide is in the range of 70:1 to 110:1. However, it should be understood that alternative values for the ratio by weight between the herbicide and the pesticide are possible.

In one form, an adjuvant may be optionally included with the pesticide and herbicide. In one form when present, the adjuvant is or includes an ammonium salt, such as ammonium sulfate. However, it should be understood that the use of other adjuvants is also contemplated. In one form, the ratio by weight between the adjuvant and the remaining composition components is in the range of 0.015:1 to 700:1. In another form, the ratio by weight between the adjuvant and the remaining composition components is in the range of 0.15:1 to 70:1. In still another form, the ratio by weight between the adjuvant and the remaining composition components is in the range of 0.4:1 to 30:1. In yet another form, the ratio by weight between the adjuvant and the remaining composition components is in the range of 0.5:1 to 6:1. In another form, the ratio by weight between the adjuvant and the remaining composition components is in the range of 2:1 to 12:1. However, it should be understood that alternative values for the ratio by weight between the adjuvant and the remaining composition components are possible.

### Insecticidal Testing

Insecticidal testing was performed using mixtures of compound A

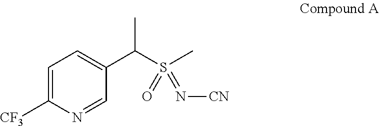 [SMILES: CC(c1ccc(C(F)(F)F)nc1)S(C)(=O)=NC#N]

and selected herbicides. Compound A is also known as sulfoxaflor (sulfoximine (2)).

### Example XV

Glyphosate resistant cotton plants (Gossypium hirsutum, cv ‘DP493’) were trimmed to 1 true leaf and infested with mixed stages of cotton aphid (CA) Aphis gossypii 24 h prior to application. Mixed developmental stage CA were infested onto the upper surface of each treated leaf by transferring infested foliage from an insectary colony. Each plant was infested with approximately equal numbers of CA based on visual estimation of aphid density on the infested material. Infested plants were held in the growth chamber (L:D 16:8 and 25° C.). Glyphosate (Glyphomax Plus, Dow AgroSciences, LLC, Indianapolis, Ind.) was mixed with water at a rate equivalent to 32 oz/Ac/20 gallons. This solution rate was 12.5 ml/L. This volume was subdivided into equal fractions and ammonium sulfate (AMS) was added to one fraction at a rate of 18 g/l. Additionally, a solution of AMS in pure water was generated (18 g/l). High rate Compound A concentrations were created by diluting Compound A technical material with acetone to achieve a 10 ppm solution. 0.2 ml of this acetone stock solution was added to either 19.8 ml of water, glyphosate solution or glyphosate and AMS solution to generate 1 ppm high rate Compound A concentrations. Successively lower concentrations were generated by serially diluting in 5-fold increments with either water, glyphosate solution or glyphosate and AMS mixture solution as appropriate to achieve solutions of 0.2 and 0.04 ppm. When applied through a track sprayer calibrated to 200 L/Ha these concentrations generated use rates of 0.2, 0.04 and 0.008 g/Ha. The track sprayer was calibrated prior to applying the Compound A formulation using a blank glyphosate and AMS solution to deliver a spray volume of 200 L/Ha through a single, hollow cone nozzle (Spraying Systems XS-6, Glendale Heights, Ill.). Nozzle height above the canopy was held constant at ca. 30 cm. Plants were evaluated after 3 days from the time of infestation by counting all live cotton aphids on each plant. A full list of compounds and formulations used and test results is provided in TABLE I.

TABLE I

| | | Glyphomax | | | | | | | | | | | |
|---|---|---|---|---|---|---|---|---|---|---|---|---|---|
| | | Plus | AMS | | | | | | | | | | |
| | g insecticide/ | Rate | Rate | CA Counts | | | | | percent control | | | | |
| Insecticide | Ha | (ml/ml) | (mg/ml) | Rep 1 | Rep 2 | Rep 3 | Rep 4 | Rep 5 | Rep 1 | Rep 2 | Rep 3 | Rep 4 | Rep 5 |
| Compound A | 0.2 | | | 24 | 20 | 12 | 15 | 13 | 69.3 | 71.7 | 78.5 | 75.1 | 75.3 |
| Compound A | 0.04 | | | 83 | 2 | 57 | 89 | 42 | −6.0 | 97.2 | −2.3 | −47.6 | 20.3 |
| Compound A | 0.008 | | | 77 | 32 | 79 | 136 | 115 | 1.7 | 54.7 | −41.8 | −125.5 | −118.2 |
| lmidacloprid | 0.2 | | | 54 | 39 | 120 | 65 | 50 | 31.0 | 44.8 | −115.4 | −7.8 | 5.1 |
| lmidacloprid | 0.04 | | | 103 | 92 | 113 | 76 | 89 | −31.5 | −30.1 | −102.9 | −26.0 | −68.9 |
| lmidacloprid | 0.008 | | | 54 | 61 | 126 | 53 | 47 | 31.0 | 13.7 | −126.2 | 12.1 | 10.8 |
| Compound A | 0.2 | 0.0125 | | 3 | 0 | 0 | 5 | 1 | 96.2 | 100.0 | 100.0 | 91.7 | 98.1 |
| Compound A | 0.04 | 0.0125 | | 55 | 30 | 27 | 62 | 47 | 29.8 | 57.6 | 51.5 | −2.8 | 10.8 |
| Compound A | 0.008 | 0.0125 | | 58 | 121 | 48 | 88 | 67 | 25.9 | −71.1 | 13.8 | −45.9 | −27.1 |
| lmidacloprid | 0.2 | 0.0125 | | 43 | 67 | 38 | 94 | 59 | 45.1 | 5.2 | 31.8 | −55.9 | −12.0 |
| Imidacloprid | 0.04 | 0.0125 | | 56 | 117 | 59 | 83 | 97 | 28.5 | −65.5 | −5.9 | −37.6 | −84.1 |
| lmidacloprid | 0.008 | 0.0125 | | 139 | 78 | 109 | 66 | 35 | −77.5 | −10.3 | −95.7 | −9.5 | 33.6 |
| Compound A | 0.2 | 0.0125 | 18 | 4 | 0 | 0 | 0 | 0 | 94.9 | 100.0 | 100.0 | 100.0 | 100.0 |
| Compound A | 0.04 | 0.0125 | 18 | 39 | 16 | 63 | 10 | 21 | 50.2 | 77.4 | −13.1 | 83.4 | 60.2 |
| Compound A | 0.008 | 0.0125 | 18 | 96 | 84 | 44 | 53 | 89 | −22.6 | −18.8 | 21.0 | 12.1 | −68.9 |
| lmidacloprid | 0.2 | 0.0125 | 18 | 18 | 38 | 76 | 43 | 37 | 77.0 | 46.3 | −36.4 | 28.7 | 29.8 |
| lmidacloprid | 0.04 | 0.0125 | 18 | 74 | 33 | 97 | 55 | 61 | 5.5 | 53.3 | −74.1 | 8.8 | −15.7 |
| lmidacloprid | 0.008 | 0.0125 | 18 | 51 | 97 | 86 | 92 | 19 | 34.9 | −37.2 | −54.4 | −52.6 | 63.9 |
| | | 0.0125 | | 132 | 88 | 96 | 93 | 97 | −68.6 | −24.5 | −72.4 | −54.2 | −84.1 |
| | | | 18 | 72 | 75 | 107 | 64 | 48 | 8.0 | −6.1 | −92.1 | −6.1 | 8.9 |
| | | 0.0125 | 18 | 63 | 89 | 99 | 103 | 116 | 19.5 | −25.9 | −77.7 | −70.8 | −120.1 |
| Untreated | | | | 79 | 66 | 43 | 25 | 59 | | | | | |
| Untreated | | | | 62 | 89 | 58 | 84 | 56 | | | | | |
| Untreated | | | | 94 | 57 | 66 | 72 | 43 | | | | | |

| | | | | | |
|---|---|---|---|---|---|
| Grand average | 78.3 | 70.7 | 55.7 | 60.3 | 52.7 |

For the purposes of this experiment, the compositions having lower rates of the insecticide were not analyzed. Percent control for all treatments was calculated using the rep average for the untreated plants. Homogeneity of variance by insecticide was tested for measured percent control (actual) and Colby predicted values at the 0.2 g insecticide/Ha rate and these data were found to have homogenous variances (Levene's test, P>>0.05). For all tests, measured efficacy (% Control) data were compared to calculated Colby values (Colby, S. R. 1967. Calculating Synergistic and Antagonistic Responses of Herbicide Combinations. Weeds 15:20-22) using a 2 sided T-test (Minitab). Significant differences (p=0.05) between measured and Colby prediction values for each compound indicated that synergy (or antagonism) was present. The formula used to calculate the Colby value for mixtures of Compound A and either herbicide or AMS was:

100−[(100−% control of insecticide)×(100−% control of herbicide, AMS, or herbicide/AMS combination)]/100.

The formula was adapted for compositions including Compound A, herbicide and AMS as follows:

100−[(100−% control of insecticide)×(100−% control of herbicide)×(100−% control of AMS)]/100.

The calculated Colby values, actual control values and results of T-test analysis are provided in Table 2.

TABLE 2

| | | Glyphomax | | | | | | | | | | | | |
|---|---|---|---|---|---|---|---|---|---|---|---|---|---|---|
| | g | Plus | AMS | % Control | | | | | Calculated | | | | | 2 sided |
| | inseciticide/ | Rate | Rate | (Negatives to zero) | | | | | Colby values | | | | | T-Test |
| Insecticide | Ha | (ml/ml) | (mg/ml) | Rep 1 | Rep 2 | Rep 3 | Rep 4 | Rep 5 | Rep 1 | Rep 2 | Rep 3 | Rep 4 | Rep 5 | (P Value) |
| Compound A | 0.2 | 0.0125 | | 96.2 | 100.0 | 100.0 | 91.7 | 98.1 | 69.3 | 71.7 | 78.5 | 75.1 | 75.3 | 0.0000 |
| Compound A | 0.04 | 0.0125 | | 29.8 | 57.6 | 51.5 | 0.0 | 10.8 | 0.0 | 97.2 | 0.0 | 0.0 | 20.3 | |
| Compound A | 0.008 | 0.0125 | | 25.9 | 0.0 | 13.8 | 0.0 | 0.0 | 1.7 | 54.7 | 0.0 | 0.0 | 0.0 | |
| Imidacloprid | 0.2 | 0.0125 | | 45.1 | 5.2 | 31.8 | 0.0 | 0.0 | 31.0 | 44.8 | 0.0 | 0.0 | 5.1 | 0.9900 |
| Imidacloprid | 0.04 | 0.0125 | | 28.5 | 0.0 | 0.0 | 0.0 | 0.0 | 0.0 | 0.0 | 0.0 | 0.0 | 0.0 | |
| Imidacloprid | 0.008 | 0.0125 | | 0.0 | 0.0 | 0.0 | 0.0 | 33.6 | 31.0 | 13.7 | 0.0 | 12.1 | 10.8 | |
| Compound A | 0.2 | 0.0125 | 18 | 94.9 | 100.0 | 100.0 | 100.0 | 100.0 | 71.8 | 71.7 | 78.5 | 75.1 | 77.5 | 0.0000 |
| Compound A | 0.04 | 0.0125 | 18 | 50.2 | 77.4 | 0.0 | 83.4 | 60.2 | 8.0 | 97.2 | 0.0 | 0.0 | 27.4 | |
| Compound A | 0.008 | 0.0125 | 18 | 0.0 | 0.0 | 21.0 | 12.1 | 0.0 | 9.5 | 54.7 | 0.0 | 0.0 | 8.9 | |
| Imidacloprid | 0.2 | 0.0125 | 18 | 77.0 | 46.3 | 0.0 | 28.7 | 29.8 | 36.6 | 44.8 | 0.0 | 0.0 | 13.6 | 0.2000 |
| Imidacloprid | 0.04 | 0.0125 | 18 | 5.5 | 53.3 | 0.0 | 8.8 | 0.0 | 8.0 | 0.0 | 0.0 | 0.0 | 8.9 | |
| Imidacloprid | 0.008 | 0.0125 | 18 | 34.9 | 0.0 | 0.0 | 0.0 | 63.9 | 36.6 | 13.7 | 0.0 | 12.1 | 18.8 | |

Table 2 suggests that the increased activity of compositions including Compound A and the herbicide is indicative of synergy that is not present when imidacloprid was tested. The addition of AMS and herbicide to Compound A also resulted in a synergyistic improvement in activity. The three way mixture of imidacloprid with AMS and herbicide was not improved compared to imidacloprid alone.

### Example XVI

Glyphosate resistant cotton plants (Gossypium hirsutum, cv ‘DP493’) were trimmed to 1 true leaf and infested with mixed stages of cotton aphid (CA) Aphis gossypii 24 h prior to application. Mixed developmental stage CA were infested onto the upper surface of each treated leaf by transferring infested foliage from an insectary colony. Each plant was infested with approximately equal numbers of CA based on visual estimation of aphid density on the infested material. Infested plants were held in the growth chamber (L:D 16:8 and 25° C.). Glyphosate (Durango®, Dow AgroSciences, LLC, Indianapolis, Ind.) was mixed with water at a rate equivalent to 15 ml/L (1.2 qt/Ac). All water used contained Tween® 20 (Sigma Aldrich, St. Louis, Mo.) adjuvant at a rate of 0.125% (V:V). A glyphosate free formulation of Durango® was prepared using these same mixing instructions. These formulated volumes were subdivided into equal fractions and AMS was added to one fraction of each at a rate of 18 g/l. Additionally, a solution of AMS in pure water was generated (18 g/l). High rate Compound A concentrations were created by diluting Compound A technical material with acetone to achieve a 10 ppm solution. 0.2 ml of this acetone stock solution was added to either 19.8 ml of water, glyphosate solution or glyphosate and AMS solution to generate 1 ppm high rate Compound A concentrations. Successively lower concentrations were generated by serially diluting in 4-fold increments with either water, glyphosate or glyphosate blank solution, or glyphosate and AMS or glyphosate and glyphosate blank mixture solutions as appropriate to achieve solutions of 0.25 and 0.0625 ppm. When applied through a track sprayer calibrated to 200 L/Ha these concentrations generated use rates of 0.2, 0.0625 and 0.015 g/Ha. The track sprayer was calibrated prior to applying the Compound A formulation using a blank glyphosate and AMS solution to deliver a spray volume of 200 L/Ha through a single, hollow cone nozzle (Spraying Systems XS-6, Glendale Heights, Ill.). Nozzle height above the canopy was held constant at ca. 30 cm. Plants were evaluated after 3 days from the time of infestation by counting all live cotton aphids on each plant. A full list of compounds and formulations used and test results is provided in TABLE 3.

TABLE 3

| | g | | Herbicide | AMS | | | | | | | | | | | |
|---|---|---|---|---|---|---|---|---|---|---|---|---|---|---|---|
| | insecticide/ | | Rate | Rate | CA Counts | | | | | % control | | | | | |
| Insecticide | Ha | Herbicide | ml/ml | (g/L) | Rep 1 | Rep 2 | Rep 3 | Rep 4 | Rep 5 | Rep 1 | Rep 2 | Rep 3 | Rep 4 | Rep 5 | Ave |
| Compound A | 0.2 | | | | 19 | 169 | 5 | 26 | 21 | 83.9 | −64.4 | 95.6 | 64.4 | 71.7 | 50.2 |
| Compound A | 0.05 | | | | 67 | 19 | 99 | 78 | 53 | 43.1 | 81.5 | 12.5 | .0.8 | 28.6 | 31.8 |
| Compound A | 0.0125 | | | | 86 | 79 | 89 | 131 | 48 | 27.0 | 23 2 | 21.4 | −79.5 | 35.3 | 5.5 |
| lmidacloprid | 0.2 | | | | 30 | 51 | 44 | 32 | 38 | 74.5 | 50.4 | 61.1 | 56.2 | 48.8 | 58.2 |
| lmidacloprid | 0.05 | | | | 78 | 71 | 30 | 66 | 73 | 33.8 | 30.9 | 73.5 | 9.6 | 1 6 | 29.9 |
| lmidacloprid | 0.0125 | | | | 47 | 100 | 67 | 87 | 81 | 60.1 | 2.7 | 40.8 | −19.2 | −9.2 | 15.1 |
| Compound A | 0.2 | Durango | 0.015 | | 12 | 4 | 27 | 6 | 3 | 89.8 | 96.1 | 76.1 | 91.8 | 96.0 | 90.0 |
| Compound A | 0.05 | Durango | 0.015 | | 83 | 118 | 99 | 52 | 82 | 29.5 | −14.8 | 12.5 | 28.8 | −10.5 | 9.1 |
| Compound A | 0.0125 | Durango | 0.015 | | 66 | 86 | 83 | 77 | 133 | 44.0 | 16.3 | 26.7 | −5.5 | −79.2 | 0.5 |
| lmidacloprid | 0.2 | Durango | 0.015 | | 20 | 62 | 32 | 50 | 73 | 83.0 | 39.7 | 71.7 | 31.5 | 1.6 | 45.5 |
| lmidacloprid | 0.05 | Durango | 0.015 | | 41 | 119 | 51 | 68 | 76 | 65.2 | −15.8 | 54.9 | 6.8 | −2.4 | 21.8 |
| lmidacloprid | 0.0125 | Durango | 0.015 | | 58 | 149 | 83 | 104 | 68 | 50.8 | −44.9 | 26.7 | −42.5 | 8.4 | −0.3 |
| Compound A | 0.2 | Durango | 0.015 | 18 | 3 | 0 | 0 | 0 | 0 | 97.5 | 100.0 | 100.0 | 100.0 | 100.0 | 99.5 |
| Compound A | 0.05 | Durango | 0.015 | 18 | 37 | 49 | 36 | 25 | 48 | 68.6 | 52.3 | 68.2 | 65.8 | 35.3 | 58.0 |
| Compound A | 0.0125 | Durango | 0.015 | 18 | 93 | 75 | 99 | 117 | 31 | 21.1 | 27.0 | 12.5 | −60.3 | 58.2 | 11.7 |
| lmidacloprid | 0.2 | Durango | 0.015 | 18 | 112 | 21 | 61 | 98 | 57 | 4.9 | 79.6 | 46.1 | −34.2 | 23.2 | 23.9 |
| lmidacloprid | 0.05 | Durango | 0.015 | 18 | 49 | 50 | 71 | 64 | 54 | 58.4 | 51.4 | 37.3 | 12.3 | 27.2 | 37.3 |
| lmidacloprid | 0.0125 | Durango | 0.015 | 18 | 92 | 93 | 83 | 56 | 37 | 21.9 | 9.5 | 26.7 | 23.3 | 50.1 | 26.3 |
| | 0 | Durango | 0.015 | | 127 | 65 | 44 | 115 | 84 | −7.8 | 36.8 | 61.1 | −57.5 | −13.2 | 3.9 |
| | 0 | | | 18 | 53 | 118 | 49 | 141 | 103 | 55.0 | −14.8 | 56.7 | −93.2 | −38.8 | −7.0 |
| | 0 | Durango | 0.015 | 18 | 50 | 56 | 137 | 57 | 74 | 57.6 | 45.5 | −21.0 | 21.9 | 0.3 | 20.8 |
| Check | | | | | 73 | 59 | 94 | 62 | 42 | 38.0 | 42.6 | 17.0 | 15.1 | 43.4 | 31.2 |
| Check | | | | | 103 | 122 | 163 | 119 | 97 | 12.6 | −18.7 | −44.0 | −63.0 | −30.7 | −28.8 |
| Check | | | | | 65 | 137 | 107 | 59 | 127 | 44.8 | −33.3 | 5.5 | 19.2 | −71.2 | −7.0 |
| Compound A | 0.2 | Durango Blank | 0.015 | | 41 | 26 | 13 | 49 | 45 | 65.2 | 74.7 | 88.5 | 32.9 | 39.4 | 60.1 |
| Compound A | 0.05 | Durango Blank | 0.015 | | 56 | 75 | 78 | 32 | 64 | 52.5 | 27.0 | 31.1 | 56.2 | 13.7 | 36.1 |
| Compound A | 0.0125 | Durango Blank | 0.015 | | 91 | 87 | 67 | 204 | 84 | 22.8 | 15.4 | 40.8 | −179.5 | −13.2 | −22.7 |
| lmidacloprid | 0.2 | Durango Blank | 0.015 | | 35 | 36 | 75 | 43 | 25 | 70.3 | 65.0 | 33.7 | 41.1 | 66.3 | 55.3 |
| lmidacloprid | 0.05 | Durango Blank | 0.015 | | 61 | 119 | 38 | 66 | 80 | 48.2 | −15.8 | 66.4 | 9.6 | −7.8 | 20.1 |
| lmidacloprid | 0.0125 | Durango Blank | 0.015 | | 167 | 64 | 183 | 117 | 46 | −41.8 | 37.7 | −61.7 | −60.3 | 38.0 | −17.6 |
| Compound A | 0.2 | Durango Blank | 0.015 | 18 | 39 | 3 | 27 | 15 | 19 | 66.9 | 97.1 | 76.1 | 79.5 | 74.4 | 78.8 |
| Compound A | 0.05 | Durango Blank | 0.015 | 18 | 49 | 115 | 70 | 27 | 52 | 58.4 | −11.9 | 38.2 | 63.0 | 29.9 | 35.5 |
| Compound A | 0.0125 | Durango Blank | 0.015 | 18 | 98 | 62 | 121 | 63 | 28 | 16.8 | 39.7 | −6.9 | 13.7 | 62.3 | 25.1 |
| lmidacloprid | 0.2 | Durango Blank | 0.015 | 18 | 96 | 41 | 20 | 87 | 78 | 18.5 | 60.1 | 82.3 | −19.2 | −5.1 | 27.3 |
| lmidacloprid | 0.05 | Durango Blank | 0.015 | 18 | 82 | 81 | 108 | 73 | 95 | 30.4 | 21.2 | 4.6 | 0.0 | −28.0 | 5.6 |
| lmidacloprid | 0.0125 | Durango Blank | 0.015 | 18 | 104 | 34 | 73 | 66 | 170 | 11.7 | 66.9 | 35.5 | 9.6 | −129.1 | −1.1 |
| | | Durango Blank | 0.015 | | 73 | 67 | 82 | 101 | 76 | 38.0 | 34.8 | 27.6 | −38.4 | −2.4 | 11.9 |
| | | | | 18 | 29 | 36 | 97 | 56 | 157 | 75.4 | 65.0 | 14.3 | 23.3 | −111.6 | 13.3 |
| | | Durango Blank | 0.015 | 18 | 106 | 95 | 45 | 53 | 54 | 10.0 | 7.6 | 60.2 | 27.4 | 27.2 | 26.5 |
| Check | | | | | 172 | 118 | 55 | 81 | 72 | −46.0 | −14.8 | 51.4 | −11.0 | 3.0 | −3.5 |
| Check | | | | | 184 | 114 | 117 | 42 | 18 | −56.2 | −10.9 | −3.4 | 42.5 | 75.7 | 9.6 |
| Check | | | | | 110 | 67 | 143 | 75 | 89 | 6.6 | 34.8 | −26.3 | −2.7 | −19.9 | −1.5 |

For the purposes of this experiment, the compositions having lower rates of the insecticide were not analyzed. Percent control for all treatments was calculated using the rep average for the untreated plants. Homogeneity of variance by compound was tested for measured percent control (actual) and Colby predicted values at the 0.2 g insecticide/Ha rate and these data were found to have homogeneous variances (Levene's test, P>>0.05). Results are provided in Table 4.

TABLE 4

| | g | | Herbi- | | | | | | | | | | | | | | |
|---|---|---|---|---|---|---|---|---|---|---|---|---|---|---|---|---|---|
| | insec- | | cide | AMS | | | | | | | | | | | | | 2 sided T- |
| | ticide/ | | Rate | Rate | % Control (Negatives to zero) | | | | | | Colbv predicted values | | | | | | Test |
| Insecticide | Ha | Herbicide | (mVml) | (g/L) | Rep 1 | Rep 2 | Rep 3 | Rep 4 | Rep 5 | Ave | Rep 1 | Rep 2 | Rep 3 | Rep 4 | Rep 5 | Ave | (PValue) |
| Compound | 0.2 | Durango | 0.015 | | 89.8 | 96.1 | 76.1 | 91.8 | 96.0 | 90.0 | 83.9 | 36.8 | 95.6 | 64.4 | 71.7 | 70.5 | 0.100 |
| A | | | | | | | | | | | | | | | | | |
| Compound | 0.05 | Durango | 0.015 | | 29.5 | 0.0 | 12.5 | 28.8 | 0.0 | 14.2 | 43.1 | 88.3 | 65.9 | 0.0 | 28.6 | 45.2 | |
| A | | | | | | | | | | | | | | | | | |
| Compound | 0.0125 | Durango | 0.015 | | 44.0 | 16.3 | 26.7 | 0.0 | 0.0 | 17.4 | 27.0 | 51.4 | 69.3 | 0.0 | 35.3 | 36.6 | |
| A | | | | | | | | | | | | | | | | | |
| lmidacloprid | 0.2 | Durango | 0.015 | | 83.0 | 39.7 | 71.7 | 31.5 | 1.6 | 45.5 | 74.5 | 68.6 | 84.8 | 56.2 | 48.8 | 66.6 | 0.220 |
| lmidacloprid | 0.05 | Durango | 0.015 | | 65.2 | 0.0 | 54.9 | 6.8 | 0.0 | 25.4 | 33.8 | 56.4 | 89.7 | 9.6 | 1.6 | 38.2 | |
| lmidacloprid | 0.0125 | Durango | 0.015 | | 50.8 | 0.0 | 26.7 | 0.0 | 6.4 | 17.2 | 60.1 | 38.5 | 76.9 | 0.0 | 0.0 | 35.1 | |
| Compound | 0.2 | Durango | 0.015 | 18 | 97.5 | 100.0 | 100.0 | 100.0 | 100.0 | 99.5 | 92.7 | 36.0 | 99.3 | 64.4 | 71.7 | 72.8 | 0.045 |
| A | | | | | | | | | | | | | | | | | |
| Compound | 0.05 | Durango | 0.015 | 18 | 68.6 | 52.3 | 68.2 | 65.8 | 35.3 | 58.0 | 74.4 | 88.2 | 85.3 | 0.0 | 28.6 | 55.3 | |
| A | | | | | | | | | | | | | | | | | |
| Compound | 0.0125 | Durango | 0.015 | 18 | 21.1 | 27.0 | 12.5 | 0.0 | 58.2 | 23.8 | 67.1 | 50.8 | 86.8 | 0.0 | 35.3 | 48.0 | |
| A | | | | | | | | | | | | | | | | | |
| lmidacloprid | 0.2 | Durango | 0.015 | 18 | 4.9 | 79.6 | 46.1 | 0.0 | 23.2 | 30.8 | 88.5 | 68.2 | 93.5 | 56.2 | 48.8 | 71.0 | 0.046 |
| lmidacloprid | 0.05 | Durango | 0.015 | 18 | 58.4 | 51.4 | 37.3 | 12.3 | 27.2 | 37.3 | 70.2 | 55.8 | 95.5 | 9.6 | 1.8 | 46.5 | |
| lmidacloprid | 0.0125 | Durango | 0.015 | 18 | 21.9 | 9.5 | 26.7 | 23.3 | 50.1 | 26.3 | 82.0 | 37.7 | 90.0 | 0.0 | 0.0 | 42.0 | |
| Compound | 0.2 | Durango | 0.015 | | 65.2 | 74.7 | 88.5 | 32.9 | 39.4 | 60.1 | 90.0 | 34.8 | 96.8 | 64.4 | 71.7 | 71.5 | 0.470 |
| A | | Blank | | | | | | | | | | | | | | | |
| Compound | 0.05 | Durango | 0.015 | | 52.5 | 27.0 | 31.1 | 56.2 | 13.7 | 36.1 | 64.7 | 87.9 | 36.7 | 0.0 | 28.6 | 43.6 | |
| A | | Blank | | | | | | | | | | | | | | | |
| Compound | 0.0125 | Durango | 0.015 | | 22.8 | 15.4 | 40.8 | 0.0 | 0.0 | 15.8 | 54.7 | 49.9 | 43.1 | 0.0 | 35.3 | 36.6 | |
| A | | Blank | | | | | | | | | | | | | | | |
| lmidacloprid | 0.2 | Durango | 0.015 | | 70.3 | 65.0 | 33.7 | 41.1 | 66.3 | 55.3 | 84.2 | 67.7 | 71.9 | 56.2 | 48.8 | 65.7 | 0.310 |
| | | Blank | | | | | | | | | | | | | | | |
| lmidacloprid | 0.05 | Durango | 0.015 | | 48.2 | 0.0 | 66.4 | 9.6 | 0.0 | 24.8 | 58.9 | 55.0 | 80.8 | 9.6 | 1.6 | 41.2 | |
| | | Blank | | | | | | | | | | | | | | | |
| lmidacloprid | 0.0125 | Durango | 0.015 | | 0.0 | 37.7 | 0.0 | 0.0 | 38.0 | 15.1 | 75.3 | 36.6 | 57.1 | 0.0 | 0.0 | 33.8 | |
| | | Blank | | | | | | | | | | | | | | | |
| Compound | 0.2 | Durango | 0.015 | 18 | 68.9 | 97.1 | 76.1 | 79.5 | 74.4 | 78.8 | 97.5 | 77.2 | 97.3 | 72.7 | 71.7 | 83.3 | 0.580 |
| A | | Blank | | | | | | | | | | | | | | | |
| Compound | 0.05 | Durango | 0.015 | 18 | 58.4 | 0.0 | 38.2 | 63.0 | 29.9 | 37.9 | 91.3 | 95.8 | 45.7 | 23.3 | 28.6 | 56.9 | |
| A | | Blank | | | | | | | | | | | | | | | |
| Compound | 0.0125 | Durango | 0.015 | 18 | 16.8 | 39.7 | 0.0 | 13.7 | 62.3 | 26.5 | 88.9 | 82.5 | 51.2 | 23.3 | 35.3 | 56.2 | |
| A | | Blank | | | | | | | | | | | | | | | |
| lmidacloprid | 0.2 | Durango | 0.015 | 18 | 18.5 | 60.1 | 82.3 | 0.0 | 0.0 | 32.2 | 96.1 | 88.7 | 75.9 | 68.4 | 48.8 | 75.2 | 0.050 |
| | | Blank | | | | | | | | | | | | | | | |
| Imidacloprid | 0.05 | Durango | 0.015 | 18 | 30.4 | 21.2 | 4.6 | 0.0 | 0.0 | 11.2 | 89.9 | 84.2 | 83.6 | 30.7 | 1.6 | 58.0 | |
| | | Blank | | | | | | | | | | | | | | | |
| lmidacloprid | 0.0125 | Durango | 0.015 | 18 | 11.7 | 68.9 | 35.5 | 9.6 | 0.0 | 24.7 | 93.9 | 77.8 | 63.3 | 23.3 | 0.0 | 51.7 | |
| | | Blank | | | | | | | | | | | | | | | |

The comparison of predicted additive values (Colby Values TABLE 4) and measured values at the 0.2 g insecticide/Ha rate tested indicates that there were no effects when only Durango® was mixed with Compound A or imidacloprid. When AMS and Durango® were co-applied with Compound A there was a significant improvement in efficacy (P=0.045). The T-test comparing the Colby and measured values for imidacloprid co-applied with Durango® and AMS resulted in antagonism of imidacloprid activity. When the Durango® blank formulation was applied with both Compound A and imidacloprid there was no significant difference between predicted and measured activity. However, when imidacloprid was co-applied with Durango blank and AMS there was an antagonistic effect on the aphicidal efficacy of imidacloprid. No difference was observed between the predicted and measured combination of Compound A, Durango blank and AMS.

### Example XVII

Glyphosate resistant cotton plants (Gossypium hirsutum, cv ‘DP493’) were trimmed to 1 true leaf and infested with mixed stages of cotton aphid (CA) Aphis gossypii 24 h prior to application. Mixed developmental stage CA were infested onto the upper surface of each treated leaf by transferring infested foliage from an insectary colony. Each plant was infested with approximately equal numbers of CA based on visual estimation of aphid density on the infested material. Infested plants were held in the growth chamber (L:D 16:8 and 25° C.). Glufosinate (Liberty®, Bayer CropScience, Monheim am Rhein, Germany) was mixed with water at a rate equivalent to 5 ml/L (0.4 qt/Ac). All water used contained Tween® 20 adjuvant at a rate of 0.125% (V:V). These formulated volumes were subdivided into equal fractions and AMS was added to one fraction of each at a rate of 18 g/L. Additionally, a solution of AMS in pure water was generated (18 g/L). High rate Compound A concentrations were created by diluting Compound A technical material with acetone to achieve a 10 ppm solution. 0.2 ml of this acetone stock solution was added to either 19.8 ml of water, glufosinate solution or glufosinate and AMS solution to generate 1 ppm high rate Compound A concentrations. Successively lower concentrations were generated by serially diluting in 4-fold increments with either water, glufosinate solution or glufosinate and AMS solution as appropriate to achieve solutions concentrations of 0.25 and 0.0625 ppm. When applied through a track sprayer calibrated to 200 L/Ha these concentrations generated use rates of 0.2, 0.0625 and 0.015 g/Ha. The track sprayer was calibrated using a blank glufosinate and AMS solution to deliver a spray volume of 200 L/Ha through a single, hollow cone nozzle (Spraying Systems XS-6). Nozzle height above the canopy was held constant at ca. 30 cm. Plants were evaluated after 3 days from the time of infestation by counting all live cotton aphids on each plant. A full list of compounds and formulations used and test results is provided in TABLE 5.

TABLE 5

| | | | Glufosinate | AMS | | | | | | | | | | | | | |
|---|---|---|---|---|---|---|---|---|---|---|---|---|---|---|---|---|---|
| | | | Rate | (mg/ | CA Counts | | | | | | % control | | | | | | |
| TRT | Insecticide | g In./Ha | (ml/ml) | ml) | Rep 1 | Rep 2 | Rep 3 | Rep 4 | Rep 5 | Rep 6 | Rep 1 | Rep 2 | Rep 3 | Rep 4 | Rep 5 | Rep 6 | AVE |
| 1 | Compound A | 0.2 | | | 17 | 14 | 6 | 16 | 6 | 21 | 77.3 | 87.9 | 91.4 | 86.4 | 91.9 | 68.2 | 87.0 |
| 2 | Compound A | 0.05 | | | 45 | 53 | 16 | 43 | 25 | 43 | 40.0 | 54.3 | 77.1 | 63.6 | 66.2 | 34.8 | 60.2 |
| 3 | Compound A | 0.0125 | | | 66 | 83 | 39 | 24 | 111 | 23 | 12.0 | 28.4 | 44.3 | 79.7 | −50.0 | 65.2 | 22.9 |
| 4 | Imidacloprid | 0.2 | | | 37 | 66 | 36 | 18 | 42 | 39 | 50.7 | 43.1 | 48.6 | 84.7 | 43.2 | 40.9 | 54.1 |
| 5 | Imidacloprid | 0.05 | | | 35 | 73 | 37 | 44 | 63 | 30 | 53.3 | 37.1 | 47.1 | 62.7 | 14.9 | 54.5 | 43.0 |
| 6 | Imidacloprid | 0.0125 | | | 42 | 41 | 50 | 78 | 54 | 25 | 44.0 | 64.7 | 28.6 | 33.9 | 27.0 | 62.1 | 39.6 |
| 7 | Compound A | 0.2 | 0.005 | | 2 | 5 | 3 | 8 | 4 | 9 | 97.3 | 95.7 | 95.7 | 93.2 | 94.6 | 86.4 | 95.3 |
| 8 | Compound A | 0.05 | 0.005 | | 14 | 23 | 19 | 1 | 17 | 7 | 81.3 | 80.2 | 72.9 | 99.2 | 77.0 | 89.4 | 82.1 |
| 9 | Compound A | 0.0125 | 0.005 | | 46 | 18 | 40 | 39 | 32 | 23 | 38.7 | 84.5 | 42.9 | 66.9 | 56.8 | 65.2 | 57.9 |
| 10 | Imidacloprid | 0.2 | 0.005 | | 21 | 43 | 21 | 45 | 56 | 64 | 72.0 | 62.9 | 70.0 | 61.9 | 24.3 | 3.0 | 58.2 |
| 11 | Imidacloprid | 0.05 | 0.005 | | 24 | 59 | 27 | 57 | 55 | 23 | 68.0 | 49.1 | 61.4 | 51.7 | 25.7 | 65.2 | 51.2 |
| 12 | Imidacloprid | 0.0125 | 0.005 | | 37 | 31 | 40 | 10 | 19 | 17 | 50.7 | 73.3 | 42.9 | 91.5 | 74.3 | 74.2 | 66.5 |
| 13 | Compound A | 0.2 | 0.005 | 18 | 1 | 7 | 4 | 3 | 1 | 4 | 98.7 | 94.0 | 94.3 | 97.5 | 98.6 | 93.9 | 96.6 |
| 14 | Compound A | 0.05 | 0.005 | 18 | 8 | 4 | 16 | 3 | 1 | 13 | 89.3 | 96.6 | 77.1 | 97.5 | 98.6 | 80.3 | 91.8 |
| 15 | Compound A | 0.0125 | 0.005 | 18 | 4 | 12 | 22 | 11 | 12 | 4 | 94.7 | 89.7 | 68.6 | 90.7 | 83.8 | 95.5 | 85.5 |
| 16 | Imidacloprid | 0.2 | 0.005 | 18 | 23 | 35 | 25 | 22 | 29 | 2 | 69.3 | 69.8 | 64.3 | 81.4 | 60.8 | 97.0 | 69.1 |
| 17 | Imidacloprid | 0.05 | 0.005 | 18 | 16 | 19 | 25 | 15 | 37 | 13 | 78.7 | 83.6 | 64.3 | 87.3 | 50.0 | 80.3 | 72.8 |
| 18 | Imidacloprid | 0.0125 | 0.005 | 18 | 11 | 3 | 6 | 19 | 4 | 3 | 85.3 | 97.4 | 91.4 | 83.9 | 94.6 | 95.5 | 90.5 |
| 19 | Water Tween | 0 | 0.02 | | 0 | 34 | 89 | 28 | 20 | 2 | 100.0 | 70.7 | −27.1 | 76.3 | 73.0 | 97.0 | 58.6 |
| 20 | Water Tween | 0 | 0.01 | | 107 | 221 | 24 | 79 | 72 | 48 | −42.7 | −90.5 | 65.7 | 33.1 | 2.7 | 27.3 | −6.3 |
| 21 | Water Tween | 0 | 0.005 | | 55 | 141 | 132 | 57 | 99 | 159 | 26.7 | −21.6 | −88.6 | 51.7 | −33.8 | 140.9 | −13.1 |
| 25 | | 0 | | 18 | 33 | 81 | 38 | 113 | 158 | 92 | 56.0 | 30.2 | 45.7 | 4.2 | −113.5 | −39.4 | 4.5 |
| 26 | | 0 | 0.005 | 18 | 9 | 61 | 14 | 8 | 56 | 41 | 88.0 | 47.4 | 80.0 | 93.2 | 24.3 | 37.9 | 66.6 |

| | | | | | | | | | |
|---|---|---|---|---|---|---|---|---|---|
| 27 | Water Tween | 48 | 145 | 53 | 116 | 57 | 80 | Grand Check Average | 86.3 |
| 28 | Water Tween | 120 | 80 | 86 | 134 | 99 | 59 | | |
| 29 | Water Tween | 56 | 123 | 72 | 103 | 65 | 58 | | |

| | | | | | | |
|---|---|---|---|---|---|---|
| Rep check average | 74.7 | 116 | 70.3 | 118 | 73.7 | 65.7 |

TABLE 6 contains the calculated Colby values for combinations of treatments as well as the outcome of statistical evaluations between predicted (Colby) and actual measured values. These T-test statistics were only calculated for the 0.2 and 0.05 g/Ha rates. The application of glufosinate and Compound A together resulted in a synergistic increase in efficacy compared to predicted values at the P=0.11 level (0.2 g/Ha) and P=0.03 at the 0.0625 g/Ha rate. The combination of glufosinate and imidacloprid was not different from the calculated additive values. These same trends were apparent when Compound A was applied with both glufosinate and AMS. In this case synergy between Compound A and glufosinate and AMS was strongly indicated. No evidence of synergy was apparent when imidacloprid was combined with glufosinate and AMS.

TABLE 6

| | | Glufosinate | | | | | | | | |
|---|---|---|---|---|---|---|---|---|---|---|
| | | Rate | | % control (Negatives to zero) | | | | | | |
| Insecticide | g In./Ha | (ml/ml) | AMS (mg/ml) | Rep 1 | Rep 2 | Rep 3 | Rep 4 | Rep 5 | Rep 6 | Ave |
| Compound A | 0.2 | 0.005 | | 97.3 | 95.7 | 95.7 | 93.2 | 94.6 | 86.4 | 95.3 |
| Compound A | 0.05 | 0.005 | | 81.3 | 80.2 | 72.9 | 99.2 | 77.0 | 89.4 | 82.1 |
| Compound A | 0.0125 | 0.005 | | 38.7 | 84.5 | 42.9 | 66.9 | 56.8 | 65.2 | 57.9 |
| Imidacloprid | 0.2 | 0.005 | | 72.0 | 62.9 | 70.0 | 61.9 | 24.3 | 3.0 | 58.2 |
| Imidacloprid | 0.05 | 0.005 | | 68.0 | 49.1 | 61.4 | 51.7 | 25.7 | 65.2 | 51.2 |
| Imidacloprid | 0.0125 | 0.005 | | 50.7 | 73.3 | 42.9 | 91.5 | 74.3 | 74.2 | 66.5 |
| Compound A | 0.2 | 0.005 | 18 | 98.7 | 94.0 | 94.3 | 97.5 | 98.6 | 93.9 | 96.6 |
| Compound A | 0.05 | 0.005 | 18 | 89.3 | 96.6 | 77.1 | 97.5 | 98.6 | 80.3 | 91.8 |
| Compound A | 0.0125 | 0.005 | 18 | 94.7 | 89.7 | 68.6 | 90.7 | 83.8 | 93.9 | 85.5 |
| Imidacloprid | 0.2 | 0.005 | 18 | 69.3 | 69.8 | 64.3 | 81.4 | 60.8 | 97.0 | 69.1 |
| Imidacloprid | 0.05 | 0.005 | 18 | 78.7 | 83.6 | 64.3 | 87.3 | 50.0 | 80.3 | 72.8 |
| Imidacloprid | 0.0125 | 0.005 | 18 | 85.3 | 97.4 | 91.4 | 83.9 | 94.6 | 95.5 | 90.5 |

| | | | | | | | | | 2 |
|---|---|---|---|---|---|---|---|---|---|
| | | Colby Predicted Values | | | | | | | Sided T- |
| Insecticide | g In./Ha | Rep 1 | Rep 2 | Rep 3 | Rep 4 | Rep 5 | Rep 6 | Ave | Test |
| Compound A | 0.2 | 77.3 | 91.2 | 95.9 | 90.1 | 91.9 | 68.2 | 85.7 | 0.11 |
| Compound A | 0.05 | 56.0 | 66.5 | 83.2 | 73.3 | 66.2 | 34.8 | 63.4 | 0.028 |
| Compound A | 0.0125 | 35.5 | 47.6 | 59.2 | 85.1 | 0.0 | 65.2 | 48.7 | |
| Imidacloprid | 0.2 | 63.8 | 58.3 | 62.3 | 88.8 | 43.2 | 40.9 | 59.6 | 0 46 |
| Imidacloprid | 0.05 | 65.8 | 53.9 | 61.3 | 72.7 | 14.9 | 54.5 | 53.8 | 0.98 |
| Imidacloprid | 0.0125 | 59.0 | 74.1 | 47.6 | 51.5 | 27.0 | 62.1 | 53.6 | |
| Compound A | 0.2 | 90.0 | 93.9 | 95.3 | 87.0 | 91.9 | 68.2 | 87.7 | 0.072 |
| Compound A | 0.05 | 73.6 | 76.9 | 87.6 | 65.1 | 66.2 | 34.8 | 67.4 | 0.021 |
| Compound A | 0.0125 | 61.3 | 63.8 | 69.7 | 80.5 | 0.0 | 65.2 | 56.8 | |
| Imidacloprid | 0.2 | 78.3 | 71.2 | 72.1 | 85.4 | 43.2 | 40.9 | 65.2 | 0.38 |
| Imidacloprid | 0.05 | 79.5 | 68.2 | 71.3 | 64.3 | 14.9 | 54.5 | 58.8 | 0.2 |
| Imidacloprid | 0.0125 | 75.4 | 82.1 | 61.2 | 36.7 | 27.0 | 62.1 | 57.4 | |

### Example XVIII

Glyphosate resistant cotton plants (Gossypium hirsutum, cv ‘DP493’) were trimmed to 1 true leaf and infested with mixed stages of cotton aphid (CA) Aphis gossypii 24 hours prior to application. Mixed developmental stage CA were infested onto the upper surface of each treated leaf by transferring infested foliage from an insectary colony. Each plant was infested with approximately equal numbers of CA based on visual estimation of aphid density on the infested material. Infested plants were held in the growth chamber (L:D 16:8 and 25° C.). Glufosinate (Liberty®, Bayer CropScience, Monheim am Rhein, Germany) was mixed with water at a rate equivalent to 5 ml/L (0.4 qt/Ac). All water used contained Tween® 20 adjuvant at a rate of 0.125% (V:V). These formulated volumes were subdivided into equal fractions and AMS was added to one fraction of each at a rate of 18 g/L. Additionally, a solution of AMS in pure water was generated (18 g/L). High rate Compound A concentrations were created by diluting Compound A technical material with acetone to achieve a 20 ppm solution. 0.2 ml of this acetone stock solution was added to either 19.8 ml of water, glufosinate solution or glufosinate and AMS solution to generate 2 ppm high rate Compound A concentrations. Successively lower concentrations were generated by serially diluting in 4-fold increments with either water, glufosinate solution or glufosinate and AMS solution as appropriate to achieve solution concentrations of 0.5 and 0.125 ppm. When applied through a track sprayer calibrated to 200 L/Ha these concentrations generated use rates of 0.4, 0.1 and 0.025 g/Ha. The track sprayer was calibrated using a blank glufosinate and AMS solution to deliver a spray volume of 200 L/Ha through a single, hollow cone nozzle (Spraying Systems XS-6). Nozzle height above the canopy was held constant at ca. 30 cm. Plants were evaluated after 3 days from the time of infestation by counting all live cotton aphids on each plant. A full list of compounds and formulations used and test results is listed in TABLE 7.

TABLE 7

| | | | Liberty | AMS | | | | | | | | | | | | |
|---|---|---|---|---|---|---|---|---|---|---|---|---|---|---|---|---|
| | | | Rate | Rate | CA Counts | | | | | | % control | | | | | |
| TRT | Insecticide | g In./Ha | (ml/ml | (g/L) | Rep 1 | Rep 2 | Rep 3 | Rep 4 | Rep 5 | Rep 6 | Rep 1 | Rep 2 | Rep 3 | Rep 4 | Rep 5 | Rep 6 |
| 1 | Compound A | 0.4 | | | 5 | 2 | 10 | 13 | 10 | 9 | 98.2 | 99.3 | 96.6 | 95.8 | 96.7 | 96.9 |
| 2 | Compound A | 0.1 | | | 95 | 91 | 136 | 83 | 87 | 176 | 65.2 | 70.0 | 54.2 | 73.5 | 70.9 | 38.7 |
| 3 | Compound A | 0.025 | | | 126 | 194 | 117 | 231 | 212 | 198 | 53.8 | 36.0 | 60.6 | 26.2 | 29.1 | 31.0 |
| 4 | Imidacloprid | 0.8 | | | 67 | 56 | 25 | 84 | 77 | 45 | 75.5 | 81.5 | 91.6 | 73.2 | 74.2 | 84.3 |
| 5 | Imidacloprid | 0.2 | | | 165 | 228 | 241 | 176 | 123 | 154 | 39.6 | 24.8 | 18.9 | 43.8 | 58.9 | 46.3 |
| 6 | Imidacloprid | 0.05 | | | 192 | 239 | 258 | 351 | 267 | 140 | 29.7 | 21.1 | 13.1 | −12.1 | 10.7 | 51.2 |
| 7 | Compound A | 0.4 | 0.005 | | 6 | 0 | 3 | 5 | 4 | 0 | 97.8 | 100.0 | 99.0 | 98.4 | 98.7 | 100.0 |
| 8 | Compound A | 0.1 | 0.005 | | 114 | 63 | 6 | 130 | 52 | 46 | 58.2 | 79.2 | 98.0 | 58.5 | 82.6 | 84.0 |
| 9 | Compound A | 0.025 | 0.005 | | 53 | 238 | 79 | 164 | 221 | 68 | 80.6 | 21.5 | 73.4 | 47.6 | 26.1 | 76.3 |
| 10 | Imidacloprid | 0.8 | 0.005 | | 34 | 81 | 86 | 68 | 92 | 130 | 87.5 | 73.3 | 71.0 | 78.3 | 69.2 | 54.7 |
| 11 | Imidacloprid | 0.2 | 0.005 | | 234 | 169 | 198 | 265 | 240 | 187 | 14.3 | 44.2 | 33.3 | 15.3 | 19.7 | 34.8 |
| 12 | Imidacloprid | 0.05 | 0.005 | | 279 | 204 | 237 | 312 | 133 | 175 | −2.2 | 32.7 | 20.2 | 0.3 | 55.5 | 39.0 |
| 13 | Compound A | 0.4 | 0.005 | 18 | 5 | 0 | 5 | 0 | 0 | 21 | 98.2 | 100.0 | 98.3 | 100.0 | 100.0 | 92.7 |
| 14 | Compound A | 0.1 | 0.005 | 18 | 13 | 32 | 26 | 59 | 3 | 52 | 95.2 | 89.4 | 91.2 | 81.2 | 99.0 | 81.9 |
| 15 | Compound A | 0.025 | 0.005 | 18 | 82 | 14 | 9 | 34 | 102 | 11 | 70.0 | 95.4 | 97.0 | 89.1 | 65.9 | 96.2 |
| 16 | Imidacloprid | 0.8 | 0.005 | 18 | 9 | 17 | 12 | 18 | 5 | 1 | 96.7 | 94.4 | 96.0 | 94.2 | 98.3 | 99.7 |
| 17 | Imidacloprid | 0.2 | 0.005 | 18 | 140 | 208 | 171 | 96 | 166 | 30 | 48.7 | 31.4 | 42.4 | 69.3 | 44.5 | 89.5 |
| 18 | Imidacloprid | 0.05 | 0.005 | 18 | 42 | 88 | 39 | 160 | 60 | 29 | 84.6 | 71.0 | 86.9 | 48.9 | 79.9 | 89.9 |
| 19 | Water Tween 20 | 0 | 0.005 | | 201 | 306 | 183 | 256 | 70 | 250 | 26.4 | −1.0 | 38.4 | 18.2 | 76.6 | 12.9 |
| 20 | Water Tween 20 | 0 | | 18 | 199 | 269 | 277 | 311 | 271 | 217 | 27.1 | 11.2 | 6.7 | 0.6 | 9.4 | 24.4 |
| 21 | Water Tween 20 | 0 | 0.005 | 18 | 31 | 13 | 76 | 90 | 201 | 50 | 88.6 | 95.7 | 74.4 | 71.2 | 32.8 | 82.6 |

| | | | | | | | | |
|---|---|---|---|---|---|---|---|---|
| 22 | Check | Water Tween 20 | 490 | 218 | 390 | 207 | 279 | 437 |
| 23 | Check | Water Tween 20 | 100 | 361 | 160 | 434 | 208 | 311 |
| 24 | Check | Water Tween 20 | 230 | 330 | 341 | 297 | 409 | 112 |

TABLE 8 contains the calculated Colby values for combinations of treatments as well as the outcome of statistical evaluations between predicted (Colby) and actual measured values. Coapplication of Compound A and glufosinate did not have a synergistic effect based on a comparison with predicted additive activity. However, when Compound A was applied with glufosinate and AMS the activity was significantly increased.

TABLE 8

| | | Lib. | | | | | | | | | | | | | | | | |
|---|---|---|---|---|---|---|---|---|---|---|---|---|---|---|---|---|---|---|
| | | Rate | AMS | | | | | | | | | | | | | | | |
| | g In./ | (ml/ | Rate | % control Negatives to zero) | | | | | | | Colby Predicted Values | | | | | | | T-Test |
| Insecticide | HA | ml) | (g/L) | Rep 1 | Rep 2 | Rep 3 | Rep 4 | Rep 5 | Rep 6 | Ave | Rep 1 | Rep 2 | Rep 3 | Rep 4 | Rep 5 | Rep 6 | Ave | P-value |
| Compound | 0.4 | | | 98.2 | 99.3 | 96.6 | 95.8 | 96.7 | 96.9 | 97.3 | | | | | | | | |
| A | | | | | | | | | | | | | | | | | | |
| Compound | 0.1 | | | 65.2 | 70.0 | 54.2 | 73.5 | 70.9 | 38.7 | 62.1 | | | | | | | | |
| A | | | | | | | | | | | | | | | | | | |
| Compound | 0025 | | | 53.8 | 36.0 | 60.6 | 26.2 | 29.1 | 31.0 | 39.5 | | | | | | | | |
| A | | | | | | | | | | | | | | | | | | |
| Imidacloprid | 0.8 | | | 75.5 | 81.5 | 91.6 | 73.2 | 74.2 | 84.3 | 80.0 | | | | | | | | |
| Imidacloprid | 0.2 | | | 39.6 | 24.8 | 18.9 | 43.8 | 58.9 | 46.3 | 38.7 | | | | | | | | |
| Imidacloprid | 0.05 | | | 29.7 | 21.1 | 13.1 | 0.0 | 10.7 | 51.2 | 19.0 | | | | | | | | |
| Compound | 0.4 | 0.005 | | 97.8 | 100.00 | 99.0 | 98.4 | 98.7 | 100.0 | 99.0 | 98 7 | 99.3 | 97.9 | 96.6 | 99.2 | 97.3 | 98.2 | |
| A | | | | | | | | | | | | | | | | | | |
| Compound | 0.1 | 0.005 | | 58.2 | 79.2 | 98.0 | 58.5 | 82.6 | 84.0 | 76.7 | 74.4 | 70.0 | 71.8 | 78.3 | 93.2 | 46.6 | 72.4 | |
| A | | | | | | | | | | | | | | | | | | |
| Compound | 0.025 | 0.005 | | 80.6 | 21.5 | 73.4 | 47.6 | 26.1 | 76.3 | 54.2 | 66.0 | 36.0 | 75.7 | 39.6 | 83.4 | 39.9 | 56.8 | 0.860 |
| A | | | | | | | | | | | | | | | | | | |
| Imidacloprid | 0.8 | 0.005 | | 87.5 | 73.3 | 71.0 | 78.3 | 69.2 | 54.7 | 72.3 | 81.9 | 81.5 | 94.8 | 78.1 | 94.0 | 86.3 | 86.1 | |
| Imidacloprid | 0.2 | 0.005 | | 14.3 | 44.2 | 33.3 | 15.3 | 19.7 | 34.8 | 27.0 | 55.5 | 24.8 | 50.0 | 54.0 | 90.4 | 53.3 | 54.6 | |
| Imidacloprid | 0.05 | 0.005 | | 0.0 | 32.7 | 20.2 | 0.3 | 55.5 | 39.0 | 24.3 | 48.2 | 21.1 | 46.5 | 18.2 | 79.1 | 57.5 | 45.1 | 0.150 |
| Compound | 0.4 | 0.005 | 18 | 98.2 | 100.0 | 98.3 | 100.0 | 100.00 | 92.7 | 98.2 | 99.0 | 99.4 | 98.1 | 96.6 | 99.3 | 97.9 | 98.4 | |
| A | | | | | | | | | | | | | | | | | | |
| Compound | 0.1 | 0.005 | 18 | 95.2 | 89.4 | 91.2 | 81.2 | 99.0 | 81.9 | 89.7 | 81.3 | 73.3 | 73.7 | 78.5 | 93.8 | 59.6 | 76.7 | |
| A | | | | | | | | | | | | | | | | | | |
| Compound | 0.025 | 0.005 | 18 | 70.0 | 95.4 | 97.0 | 89.1 | 65.9 | 96.2 | 85.6 | 75.2 | 43.2 | 77.4 | 40.0 | 85.0 | 54.6 | 62.5 | 0.041 |
| A | | | | | | | | | | | | | | | | | | |
| Imidacloprid | 0.8 | 0.005 | 18 | 96.7 | 94.4 | 96.0 | 94.2 | 98.3 | 99.7 | 96.5 | 86.8 | 83.6 | 95.2 | 78.2 | 94.5 | 89.7 | 88.0 | |
| Imidacloprid | 0.2 | 0.005 | 18 | 48.7 | 31.4 | 42.4 | 69.3 | 44.5 | 89.5 | 54.3 | 67.6 | 33.2 | 53.4 | 54.3 | 91.3 | 64.7 | 60.7 | |
| Imidacloprid | 0.05 | 0.005 | 18 | 84.6 | 71.0 | 86.9 | 48.9 | 79.9 | 89.9 | 76.9 | 62.3 | 30.0 | 50.1 | 18.7 | 81.1 | 67.9 | 51.7 | 0.060 |
| | 0 | 0.005 | | 26.4 | 0.0 | 38.4 | 18.2 | 76.6 | 12.9 | 28.6 | | | | | | | | |
| | 0 | | 18 | 27.1 | 11.2 | 6.7 | 0.6 | 9.4 | 24.4 | 13.2 | | | | | | | | |
| | 0 | 0.005 | 18 | 88.6 | 95.7 | 74.4 | 71.2 | 32.8 | 82.6 | 74.2 | | | | | | | | |

### Example XIX

Glyphosate resistant cotton plants (Gossypium hirsutum, cv ‘DP493’) were trimmed to 1 true leaf and infested with mixed stages of cotton aphid (CA) Aphis gossypii 24 h prior to application. Mixed developmental stage CA were infested onto the upper surface of each treated leaf by transferring infested foliage from an insectary colony. Each plant was infested with approximately equal numbers of CA based on visual estimation of aphid density on the infested material. Infested plants were held in the growth chamber (L:D 16:8 and 25° C.).

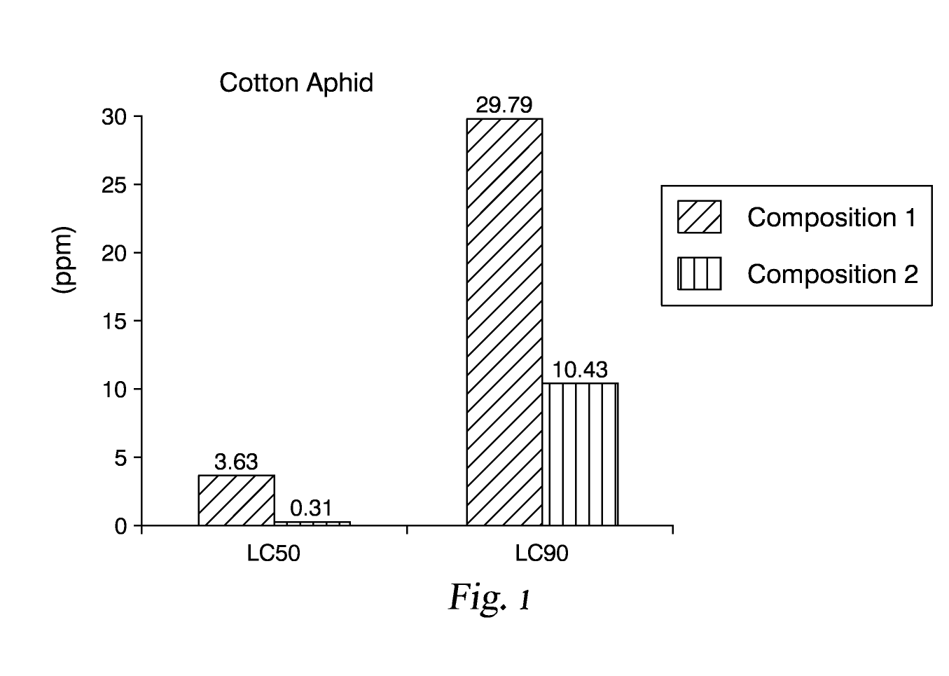

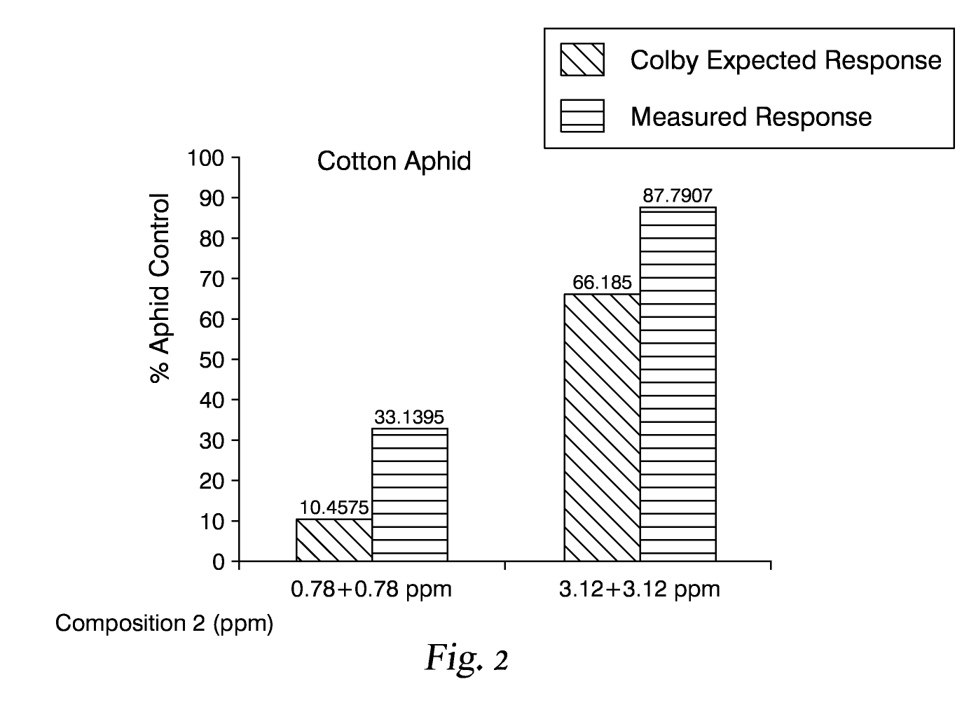

Bioefficacy tests were performed utilizing formulations of Compound A (Composition 1), Glyphosate (Roundup® Pro, The Scotts Company, LLC, Marysville, Ohio), a mixture of Compound A and Glyphosate (Composition 2), and water. Each of these formulations also included 0.03% Silwet® L-77 Surfactant (Helena Chemical Company, Collierville, Tenn.). The formulations of Compound A and Glyphosate were each tested at 50, 12.5, 3.125 and 0.78 ppm. Composition 2 included a 1:1 ratio between Compound A and Glyphosate and was tested at 50, 12.5, 3.12 and 0.78 ppm for each of these components. The various concentrations of these formulations were applied with a track sprayer calibrated to 200 L/Ha. Syngergy bioassays were conducted on plants treated the same day, and final CA counts were taken three days after infestation. Log-Probit regression analysis was conducted to generate LC50/90 values for each formulation and at each aging interval. Synergy effect analysis was also conducted using the Colby Formula. The results of these analyses are shown in FIGS. 1 and 2, respectively.

### Acid & Salt Derivatives, and Solvates

The compounds disclosed in this document can be in the form of pesticidally acceptable acid addition salts.

By way of non-limiting example, an amine function can form salts with hydrochloric, hydrobromic, sulfuric, phosphoric, acetic, benzoic, citric, malonic, salicylic, malic, fumaric, oxalic, succinic, tartaric, lactic, gluconic, ascorbic, maleic, aspartic, benzenesulfonic, methanesulfonic, ethanesulfonic, hydroxymethanesulfonic, and hydroxyethanesulfonic, acids.

Additionally, by way of non-limiting example, an acid function can form salts including those derived from alkali or alkaline earth metals and those derived from ammonia and amines. Examples of preferred cations include sodium, potassium, magnesium, and aminium cations.

The salts are prepared by contacting the free base form with a sufficient amount of the desired acid to produce a salt. The free base forms may be regenerated by treating the salt with a suitable dilute aqueous base solution such as dilute aqueous NaOH, potassium carbonate, ammonia, and sodium bicarbonate. As an example, in many cases, a pesticide is modified to a more water soluble form e.g. 2,4-dichlorophenoxy acetic acid dimethyl amine salt is a more water soluble form of 2,4-dichlorophenoxy acetic acid a well known herbicide.

The compounds disclosed in this document can also form stable complexes with solvent molecules that remain intact after the non-complexed solvent molecules are removed from the compounds. These complexes are often referred to as “solvates”.

### Stereoisomers

Certain compounds disclosed in this document can exist as one or more stereoisomers. The various stereoisomers include geometric isomers, diastereomers, and enantiomers. Thus, the compounds disclosed in this document include racemic mixtures, individual stereoisomers, and optically active mixtures. It will be appreciated by those skilled in the art that one stereoisomer may be more active than the others. Individual stereoisomers and optically active mixtures may be obtained by selective synthetic procedures, by conventional synthetic procedures using resolved starting materials, or by conventional resolution procedures.

### Pests

In another embodiment, the compositions disclosed in this document can be used to control pests.

In another embodiment, the compositions disclosed in this document can be used to control pests of the Phylum Nematoda.

In another embodiment, the compositions disclosed in this document can be used to control pests of the Phylum Arthropoda.

In another embodiment, the compositions disclosed in this document can be used to control pests of the Subphylum Chelicerata.

In another embodiment, the compositions disclosed in this document can be used to control pests of the Class Arachnida.

In another embodiment, the compositions disclosed in this document can be used to control pests of the Subphylum Myriapoda.

In another embodiment, the compositions disclosed in this document can be used to control pests of the Class Symphyla.

In another embodiment, the compositions disclosed in this document can be used to control pests of the Subphylum Hexapoda.

In another embodiment, the compositions disclosed in this document can be used to control pests of the Class Insecta.

In another embodiment, the compositions disclosed in this document can be used to control Coleoptera (beetles). A non-exhaustive list of these pests includes, but is not limited to, Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys fuscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle), and Zabrus tenebioides.

In another embodiment, the compositions disclosed in this document can be used to control Dermaptera (earwigs).

In another embodiment, the compositions disclosed in this document can be used to control Dictyoptera (cockroaches). A non-exhaustive list of these pests includes, but is not limited to, Blattella germanica (German cockroach), Blatta orientalis (oriental cockroach), Parcoblatta pennylvanica, Periplaneta americana (American cockroach), Periplaneta australoasiae (Australian cockroach), Periplaneta brunnea (brown cockroach), Periplaneta fuliginosa (smokybrown cockroach), Pyncoselus suninamensis (Surinam cockroach), and Supella longipalpa (brownbanded cockroach).

In another embodiment, the invention disclosed in this document can be used to control Diptera (true flies). A non-exhaustive list of these pests includes, but is not limited to, Aedes spp. (mosquitoes), Agromyzafrontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cochliomyia spp. (screwworms), Contarinia spp. (Gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (fit fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies), and Tipula spp. (crane flies).

In another embodiment, the compositions disclosed in this document can be used to control Hemiptera (true bugs). A non-exhaustive list of these pests includes, but is not limited to, Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Phytocoris spp. (plant bugs), Phytocoris califormicus, Phytocoris relativus, Piezodorus guildingi, Poecilocapsus lineatus (fourlined plant bug), Psallus vaccinicola, Pseudacysta perseae, Scaptocoris castanea, and Triatoma spp. (bloodsucking conenose bugs/kissing bugs).

In another embodiment, the compositions disclosed in this document can be used to control Homoptera (aphids, scales, whiteflies, leafhoppers). A non-exhaustive list of these pests includes, but is not limited to, Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bernisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), kerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale), and Zulia entreriana.

In another embodiment, the compositions disclosed in this document can be used to control Hymenoptera (ants, wasps, and bees). A non-exhaustive list of these pests includes, but is not limited to, Acromyrrmex spp., Athalia rosae, Atta spp. (leafcutting ants), Camponotus spp. (carpenter ants), Diprion spp. (sawflies), Formica spp. (ants), Iridomyrmex humilis (Argentine ant), Monomorium ssp., Monomorium minumum (little black ant), Monomorium pharaonic (Pharaoh ant), Neodiprion spp. (sawflies), Pogonomyrmex spp. (harvester ants), Polistes spp. (paper wasps), Solenopsis spp. (fire ants), Tapoinoma sessile (odorous house ant), Tetranomorium spp. (pavement ants), Vespula spp. (yellow jackets), and Xylocopa spp. (carpenter bees).

In another embodiment, the compositions disclosed in this document can be used to control Isoptera (termites). A non-exhaustive list of these pests includes, but is not limited to, Coptotermes spp., Coptotermes curvignathus, Coptotermes frenchii, Coptotermes formosanus (Formosan subterranean termite), Cornitermes spp. (nasute termites), Cryptotermes spp. (drywood termites), Heterotermes spp. (desert subterranean termites), Heterotermes aureus, Kalotermes spp. (drywood termites), Incistitermes spp. (drywood termites), Macrotermes spp. (fungus growing termites), Marginitermes spp. (drywood termites), Microcerotermes spp. (harvester termites), Microtermes obesi, Procornitermes spp., Reticulitermes spp. (subterranean termites), Reticulitermes banyulensis, Reticulitermes grassei, Reticulitermes flavipes (eastern subterranean termite), Reticulitermes hageni, Reticulitermes hesperus (western subterranean termite), Reticulitermes santonensis, Reticulitermes speratus, Reticulitermes tibialis, Reticulitermes virginicus, Schedorhinotermes spp., and Zootermopsis spp. (rotten-wood termites).

In another embodiment, the compositions disclosed in this document can be used to control Lepidoptera (moths and butterflies). A non-exhaustive list of these pests includes, but is not limited to, Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera fugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer), and Zeuzera pyrina (leopard moth).

In another embodiment, the compositions disclosed in this document can be used to control Mallophaga (chewing lice). A non-exhaustive list of these pests includes, but is not limited to, Bovicola ovis (sheep biting louse), Menacanthus stramineus (chicken body louse), and Menopon gallinea (common hen house).

In another embodiment, the compositions disclosed in this document can be used to control Orthoptera (grasshoppers, locusts, and crickets). A non-exhaustive list of these pests includes, but is not limited to, Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), chistocerca gregaria, Scudderia furcata (forktailed bush katydid), and Valanga nigricorni.

In another embodiment, the compositions disclosed in this document can be used to control Phthiraptera (sucking lice). A non-exhaustive list of these pests includes, but is not limited to, Haematopinus spp. (cattle and hog lice), Linognathus ovillus (sheep louse), Pediculus humanus capitis (human body louse), Pediculus humanus humanus (human body lice), and Pthirus pubis (crab louse).

In another embodiment, the compositions disclosed in this document can be used to control Siphonaptera (fleas). A non-exhaustive list of these pests includes, but is not limited to, Ctenocephalides canis (dog flea), Ctenocephalides felis (cat flea), and Pulex irritans (human flea).

In another embodiment, the compositions disclosed in this document can be used to control Thysanoptera (thrips). A non-exhaustive list of these pests includes, but is not limited to, Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis, and Thrips spp.

In another embodiment, the compositions disclosed in this document can be used to control Thysanura (bristletails). A non-exhaustive list of these pests includes, but is not limited to, Lepisma spp. (silverfish) and Thermobia spp. (firebrats).

In another embodiment, the compositions disclosed in this document can be used to control Acarina (mites and ticks). A non-exhaustive list of these pests includes, but is not limited to, Acarapsis woodi (tracheal mite of honeybees), Acarus spp. (food mites), Acarus siro (grain mite), Aceria mangiferae (mango bud mite), Aculops spp., Aculops lycopersici (tomato russet mite), Aculops pelekasi, Aculus pelekassi, Aculus schlechtendali (apple rust mite), Amblyomma americanum (lone star tick), Boophilus spp. (ticks), Brevipalpus obovatus (privet mite), Brevipalpus phoenicis (red and black flat mite), Demodex spp. (mange mites), Dermacentor spp. (hard ticks), Dermacentor variabilis (american dog tick), Dermatophagoides pteronyssinus (house dust mite), Eotetranycus spp., Eotetranychus carpini (yellow spider mite), Epitimerus spp., Eriophyes spp., Ixodes spp. (ticks), Metatetranycus spp., Notoedres cati, Oligonychus spp., Oligonychus coffee, Oligonychus ilicus (southern red mite), Panonychus spp., Panonychus citri (citrus red mite), Panonychus ulmi (European red mite), Phyllocoptruta oleivora (citrus rust mite), Polyphagotarsonemun latus (broad mite), Rhipicephalus sanguineus (brown dog tick), Rhizoglyphus spp. (bulb mites), Sarcoptes scabiei (itch mite), Tegolophus perseaflorae, Tetranychus spp., Tetranychus urticae (twospotted spider mite), and Varroa destructor (honey bee mite).

In another embodiment, the compositions disclosed in this document can be used to control Nematoda (nematodes). A non-exhaustive list of these pests includes, but is not limited to, Aphelenchoides spp. (bud and leaf & pine wood nematodes), Belonolaimus spp. (sting nematodes), Criconemella spp. (ring nematodes), Dirofilaria immitis (dog heartwom), Ditylenchus spp. (stem and bulb nematodes), Heterodera spp. (cyst nematodes), Heterodera zeae (corn cyst nematode), Hirschmanniella spp. (root nematodes), Hoplolaimus spp. (lance nematodes), Meloidogyne spp. (root knot nematodes), Meloidogyne incognita (root knot nematode), Onchocerca volvulus (hook-tail worm), Pratylenchus spp. (lesion nematodes), Radopholus spp. (burrowing nematodes), and Rotylenchus reniformis (kidney-shaped nematode).

In another embodiment, the compositions disclosed in this document can be used to control Symphyla (symphylans). A non-exhaustive list of these pests includes, but is not limited to, Scutigerella immaculata.

For more detailed information consult “Handbook of Pest Control—The Behavior, Life Histroy, and Control of Household Pests” by Arnold Mallis, 9^{th} Edition, copyright 2004 by GIE Media Inc.

### Mixtures

Some of the pesticides that can be employed beneficially in combination with the compositions disclosed in this document include, but are not limited to the following:

1,2 dichloropropane, 1,3 dichloropropene,

abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate,

barium hexafluorosilicate, barthrin, benclothiaz, bendiocarb, benfuracarb, benomyl, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluoron, borax, boric acid, bromfenvinfos, bromo DDT, bromocyclen, bromophos, bromophos ethyl, bromopropylate, bufencarb, buprofezin, butacarb, butathiofos, butocarboxim, butonate, butoxycarboxim,

cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A&B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate,

d-limonene, dazomet, DBCP, DCIP, DDT, decarbofuran, deltamethrin, demephion, demephion O, demephion S, demeton, demeton methyl, demeton O, demeton O methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfuram, disulfoton, dithicrofos, DNOC, dofenapyn, doramectin,

ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD,

famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural,

gamma cyhalothrin, gamma HCH,

halfenprox, halofenozide, HCH, HEOD, heptachlor, heptenophos, heterophos, hexaflumuron, hexythiazox, HHDN, hydramethylnon, hydrogen cyanide, hydroprene, hyquincarb,

imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin

jasmolin I, jasmolin II, jodfenphos, juvenile hormone I, juvenile hormone II, juvenile hormone III,

kelevan, kinoprene,

lambda cyhalothrin, lead arsenate, lepimectin, leptophos, lindane, lirimfos, lufenuron, lythidathion,

malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin,

naftalofos, naled, naphthalene, nicotine, nifluridide, nikkomycins, nitenpyram, nithiazine, nitrilacarb, novaluron, noviflumuron,

omethoate, oxamyl, oxydemeton methyl, oxydeprofos, oxydisulfoton,

paradichlorobenzene, parathion, parathion methyl, penfluoron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp′ DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen,

quassia, quinalphos, quinalphos, quinalphos methyl, quinothion, quantifies,

rafoxanide, resmethrin, rotenone, ryania,

sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfuram, sulfluramid, sulfotep, sulfur, sulfuryl fluoride, sulprofos,

tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene,

vamidothion, vamidothion, vaniliprole, vaniliprole,

XMC, xylylcarb,

zeta cypermethrin and zolaprofos.

Additionally, any combination of the above pesticides can be used.

The compositions disclosed in this document may also be used with antimicrobials, bactericides, defoliants, safeners, synergists, algaecides, attractants, desiccants, pheromones, repellants, animal dips, avicides, disinfectants, semiochemicals, and molluscicides (these categories not necessarily mutually exclusive) for reasons of economy, and synergy.

For more information consult “Compendium of Pesticide Common Names” located at http://www.alanwood.net/pesticides/index.html as of the filing date of this document. Also consult “The Pesticide Manual” 14^{th} Edition, edited by C D S Tomlin, copyright 2006 by British Crop Production Council.

### Synergistic Mixtures

The compositions disclosed in this document can be used with other compounds such as the ones mentioned under the heading “Mixtures” to form further synergistic mixtures where the mode of action of the compositions in the mixtures are the same, similar, or different.

Examples of mode of actions include, but are not limited to: acetyl choline esterase inhibitor; sodium channel modulator; chitin biosynthesis inhibitor; GABA-gated chloride channel antagonist; GABA and glutamate-gated chloride channel agonist; acetyl choline receptor agonist; MET I inhibitor; Mg-stimulated ATPase inhibitor; nicotinic acetylcholine receptor; Midgut membrane disrupter; and oxidative phosphorylation disrupter.

Additionally, the following compounds are known as synergists and can be used with the disclosed in this document: piperonyl butoxide, piprotal, propyl isome, sesamex, sesamolin, and sulfoxide.

### Formulations

The compositions described in this document may also be provided with phytologically-acceptable inert ingredients to provide or complement a carrier and can be formulated into, for example, baits, concentrated emulsions, dusts, emulsifiable concentrates, fumigants, gels, granules, microencapsulations, seed treatments, suspension concentrates, suspoemulsions, tablets, water soluble liquids, water dispersible granules or dry flowables, wettable powders, and ultra low volume solutions.

For further information on formulation types see “CATALOGUE OF PESTICIDE FORMULATION TYPES AND INTERNATIONAL CODING SYSTEM” Technical Monograph n^{o}2, 5th Edition by CropLife International (2002).

Pesticide compositions can be frequently applied as aqueous suspensions or emulsions prepared from concentrated formulations of such compositions. Such water-soluble, water-suspendable, or emulsifiable formulations are either solids, usually known as wettable powders, or water dispersible granules, or liquids usually known as emulsifiable concentrates, or aqueous suspensions. Wettable powders, which may be compacted to form water dispersible granules, comprise an intimate mixture of the pesticide composition, a carrier, and surfactants. The carrier is usually chosen from among the attapulgite clays, the montmorillonite clays, the diatomaceous earths, or the purified silicates. Effective surfactants, which can comprise from about 0.5% to about 10% of the wettable powder, are found among sulfonated lignins, condensed naphthalenesulfonates, naphthalenesulfonates, alkylbenzenesulfonates, alkyl sulfates, and nonionic surfactants such as ethylene oxide adducts of alkyl phenols.

Emulsifiable concentrates comprise a convenient concentration of a pesticide composition dissolved in a carrier that is either a water miscible solvent or a mixture of water-immiscible organic solvent and emulsifiers. Useful organic solvents include aromatics, especially xylenes and petroleum fractions, especially the high-boiling naphthalenic and olefinic portions of petroleum such as heavy aromatic naphtha. Other organic solvents may also be used, such as the terpenic solvents including rosin derivatives, aliphatic ketones such as cyclohexanone, and complex alcohols such as 2-ethoxyethanol. Suitable emulsifiers for emulsifiable concentrates are chosen from conventional anionic and nonionic surfactants.

Aqueous suspensions comprise suspensions of water-insoluble pesticide compositions dispersed in an aqueous carrier. Suspensions are prepared by finely grinding the pesticide composition and vigorously mixing it into a carrier comprised of water and surfactants. Ingredients, such as inorganic salts and synthetic or natural gums, may also be added, to increase the density and viscosity of the aqueous carrier. It is often most effective to grind and mix the pesticide composition at the same time by preparing the aqueous mixture and homogenizing it in an implement such as a sand mill, ball mill, or piston-type homogenizer.

Pesticide compositions may also be applied as granular formulations that are particularly useful for applications to the soil. Granular formulations contain the pesticide composition dispersed in a carrier that comprises clay or a similar substance. Such formulations are usually prepared by dissolving the pesticide composition in a suitable solvent and applying it to a granular carrier which has been pre-formed to the appropriate particle size, in the range of from about 0.5 to 3 mm. Such formulations may also be formulated by making a dough or paste of the carrier and pesticide composition and crushing and drying to obtain the desired granular particle size.

Dusts containing a pesticide composition are prepared by intimately mixing the pesticide composition in powdered form with a suitable dusty agricultural carrier, such as kaolin clay, ground volcanic rock, and the like. Dusts can be applied as a seed dressing, or as a foliage application with a dust blower machine.

It is equally practical to apply a pesticide composition in the form of a solution in an appropriate organic solvent, usually petroleum oil, such as the spray oils, which are widely used in agricultural chemistry.

Pesticide compositions can also be applied in the form of an aerosol formulation. In such formulations, the pesticide composition is dissolved or dispersed in a carrier, which is a pressure-generating propellant mixture. The aerosol formulation is packaged in a container from which the mixture is dispensed through an atomizing valve.

Pesticide baits are formed when the pesticide composition is mixed with food or an attractant or both. When the pests eat the bait they also consume the pesticide composition. Baits may take the form of granules, gels, flowable powders, liquids, or solids. They may be used in or around pest harborages.

Fumigants are pesticides that have a relatively high vapor pressure and hence can exist as a gas in sufficient concentrations to kill pests in soil or enclosed spaces. The toxicity of the fumigant is proportional to its concentration and the exposure time. They are characterized by a good capacity for diffusion and act by penetrating the pest's respiratory system or being absorbed through the pest's cuticle. Fumigants are applied to control stored product pests under gas proof sheets, in gas sealed rooms or buildings or in special chambers.

Oil solution concentrates are made by dissolving a pesticide composition in a solvent that will hold the pesticide composition in solution. Oil solutions of a pesticide composition usually provide faster knockdown and kill of pests than other formulations due to the solvents themselves having pesticidal action and the dissolution of the waxy covering of the integument increasing the speed of uptake of the pesticide. Other advantages of oil solutions include better storage stability, better penetration of crevices, and better adhesion to greasy surfaces.

Another embodiment is an oil-in-water emulsion, wherein the emulsion comprises oily globules which are each provided with a lamellar liquid crystal coating and are dispersed in an aqueous phase, wherein each oily globule comprises at least one compound which is agriculturally active, and is individually coated with a monolamellar or oligolamellar layer comprising: (1) at least one non-ionic lipophilic surface-active agent, (2) at least one non-ionic hydrophilic surface-active agent and (3) at least one ionic surface-active agent, wherein the globules having a mean particle diameter of less than 800 nanometers. Further information on the embodiment is disclosed in U.S. patent publication 20070027034 published Feb. 1, 2007, having patent application Ser. No. 11/495,228. For ease of use this embodiment will be referred to as “OIWE”.

For further information consult “INSECT PEST MANAGEMENT” 2nd Edition by D. Dent, copyright CAB International (2000). Additionally, for more detailed information consult “HANDBOOK OF PEST CONTROL—THE BEHAVIOR, LIFE HISTORY, AND CONTROL OF HOUSEHOLD PESTS” by Arnold Mallis, 9th Edition, copyright 2004 by GIE Media Inc.

### Other Formulation Components

Generally, the compositions disclosed in this document can also contain other components. These components include, but are not limited to, (this is a non-exhaustive and non-mutually exclusive list) wetters, spreaders, stickers, penetrants, buffers, sequestering agents, drift reduction agents, compatibility agents, anti-foam agents, cleaning agents, rheology agents, stabilizers, dispersing agents and emulsifiers. A few components are described forthwith.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank to reduce the wetting time of wettable powders and to improve the penetration of water into water-dispersible granules. Examples of wetting agents used in wettable powder, suspension concentrate, and water-dispersible granule formulations are: sodium lauryl sulphate; sodium dioctyl sulphosuccinate; alkyl phenol ethoxylates; and aliphatic alcohol ethoxylates.

A dispersing agent is a substance which adsorbs onto the surface of particles and helps to preserve the state of dispersion of the particles and prevents them from reaggregating. Dispersing agents are added to agrochemical formulations to facilitate dispersion and suspension during manufacture, and to ensure the particles redisperse into water in a spray tank. They are widely used in wettable powders, suspension concentrates and water-dispersible granules. Surfactants that are used as dispersing agents have the ability to adsorb strongly onto a particle surface and provide a charged or steric barrier to reaggregation of particles. The most commonly used surfactants are anionic, non-ionic, or mixtures of the two types. For wettable powder formulations, the most common dispersing agents are sodium lignosulphonates. For suspension concentrates, very good adsorption and stabilization are obtained using polyelectrolytes, such as sodium naphthalene sulphonate formaldehyde condensates. Tristyrylphenol ethoxylate phosphate esters are also used. Non-ionics such as alkylarylethylene oxide condensates and EO-PO block copolymers are sometimes combined with anionics as dispersing agents for suspension concentrates. In recent years, new types of very high molecular weight polymeric surfactants have been developed as dispersing agents. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. Examples of dispersing agents used in agrochemical formulations are: sodium lignosulphonates; sodium naphthalene sulphonate formaldehyde condensates; tristyrylphenol ethoxylate phosphate esters; aliphatic alcohol ethoxylates; alky ethoxylates; EO-PO block copolymers; and graft copolymers.

An emulsifying agent is a substance which stabilizes a suspension of droplets of one liquid phase in another liquid phase. Without the emulsifying agent the two liquids would separate into two immiscible liquid phases. The most commonly used emulsifier blends contain alkylphenol or aliphatic alcohol with 12 or more ethylene oxide units and the oil-soluble calcium salt of dodecylbenzene sulphonic acid. A range of hydrophile-lipophile balance (“HLB”) values from 8 to 18 will normally provide good stable emulsions. Emulsion stability can sometimes be improved by the addition of a small amount of an EO-PO block copolymer surfactant.

A solubilizing agent is a surfactant which will form micelles in water at concentrations above the critical micelle concentration. The micelles are then able to dissolve or solubilize water-insoluble materials inside the hydrophobic part of the micelle. The types of surfactants usually used for solubilization are non-ionics: sorbitan monooleates; sorbitan monooleate ethoxylates; and methyl oleate esters.

Surfactants are sometimes used, either alone or with other additives such as mineral or vegetable oils as adjuvants to spray-tank mixes to improve the biological performance of the pesticide on the target. The types of surfactants used for bioenhancement depend generally on the nature and mode of action of the pesticide. However, they are often non-ionics such as: alky ethoxylates; linear aliphatic alcohol ethoxylates; aliphatic amine ethoxylates.

Organic solvents are used mainly in the formulation of emulsifiable concentrates, ULV formulations, and to a lesser extent granular formulations. Sometimes mixtures of solvents are used. The first main groups of solvents are aliphatic paraffinic oils such as kerosene or refined paraffins. The second main group and the most common comprises the aromatic solvents such as xylene and higher molecular weight fractions of C9 and C10 aromatic solvents. Chlorinated hydrocarbons are useful as cosolvents to prevent crystallization of pesticides when the formulation is emulsified into water. Alcohols are sometimes used as cosolvents to increase solvent power.

Thickeners or gelling agents are used mainly in the formulation of suspension concentrates, emulsions and suspoemulsions to modify the rheology or flow properties of the liquid and to prevent separation and settling of the dispersed particles or droplets. Thickening, gelling, and anti-settling agents generally fall into two categories, namely water-insoluble particulates and water-soluble polymers. It is possible to produce suspension concentrate formulations using clays and silicas. Examples of these types of materials, include, but are limited to, montmorillonite, e.g. bentonite; magnesium aluminum silicate; and attapulgite. Water-soluble polysaccharides have been used as thickening-gelling agents for many years. The types of polysaccharides most commonly used are natural extracts of seeds and seaweeds are synthetic derivatives of cellulose. Examples of these types of materials include, but are not limited to, guar gum; locust bean gum; carrageenam; alginates; methyl cellulose; sodium carboxymethyl cellulose (SCMC); hydroxyethyl cellulose (HEC). Other types of anti-settling agents are based on modified starches, polyacrylates, polyvinyl alcohol and polyethylene oxide. Another good anti-settling agent is xanthan gum.

Microorganisms cause spoilage of formulated products. Therefore preservation agents are used to eliminate or reduce their effect. Examples of such agents include, but are not limited to: propionic acid and its sodium salt; sorbic acid and its sodium or potassium salts; benzoic acid and its sodium salt; p-hydroxy benzoic acid sodium salt; methyl p-hydroxy benzoate; and 1,2-benzisothiazalin-3-one (BIT).

The presence of surfactants, which lower interfacial tension, often causes water-based formulations to foam during mixing operations in production and in application through a spray tank. In order to reduce the tendency to foam, anti-foam agents are often added either during the production stage or before filling into bottles. Generally, there are two types of anti-foam agents, namely silicones and non-silicones. Silicones are usually aqueous emulsions of dimethyl polysiloxane while the non-silicone anti-foam agents are water-insoluble oils, such as octanol and nonanol, or silica. In both cases, the function of the anti-foam agent is to displace the surfactant from the air-water interface.

For further information see “CHEMISTRY AND TECHNOLOGY OF AGROCHEMICAL FORMULATIONS” edited by D. A. Knowles, copyright 1998 by Kluwer Academic Publishers. Also see “INSECTICIDES IN AGRICULTURE AND ENVIRONMENT—RETROSPECTS AND PROSPECTS” by A. S. Perry, I. Yamamoto, I. Ishaaya, and R. Perry, copyright 1998 by Springer-Verlag.

### Applications

The actual amount of a pesticide composition to be applied to loci of pests is not critical and can readily be determined by those skilled in the art. In general, concentrations from about 0.01 grams of pesticide per hectare to about 5000 grams of pesticide per hectare are expected to provide good control.

The locus to which a pesticide is applied can be any locus inhabited by an pest, for example, vegetable crops, fruit and nut trees, grape vines, ornamental plants, domesticated animals, the interior or exterior surfaces of buildings, and the soil around buildings.

Generally, with baits, the baits are placed in the ground where, for example, termites can come into contact with the bait. Baits can also be applied to a surface of a building, (horizontal, vertical, or slant, surface) where, for example, ants, termites, cockroaches, and flies, can come into contact with the bait.

Because of the unique ability of the eggs of some pests to resist pesticides repeated applications may be desirable to control newly emerged larvae.

Systemic movement of pesticides in plants may be utilized to control pests on one portion of the plant by applying the pesticides to a different portion of the plant. For example, control of foliar-feeding insects can be controlled by drip irrigation or furrow application, or by treating the seed before planting. Seed treatment can be applied to all types of seeds, including those from which plants genetically transformed to express specialized traits will germinate. Representative examples include those expressing proteins toxic to invertebrate pests, such as Bacillus thuringiensis or other insecticidal toxins, those expressing herbicide resistance, such as “Roundup Ready” seed, or those with “stacked” foreign genes expressing insecticidal toxins, herbicide resistance, nutrition-enhancement or any other beneficial traits. Furthermore, such seed treatments with the compositions disclosed in this document can further enhance the ability of a plant to better withstand stressful growing conditions. This results in a healthier, more vigorous plant, which can lead to higher yields at harvest time.

The compositions disclosed in this document are suitable for controlling endoparasites and ectoparasites in the veterinary medicine sector or in the field of animal keeping. The compositions are applied here in a known manner, such as by oral administration in the form of, for example, tablets, capsules, drinks, granules, by dermal application in the form of, for example, dipping, spraying, pouring on, spotting on, and dusting, and by parenteral administration in the form of, for example, an injection.

The compositions disclosed in this document can also be employed advantageously in livestock keeping, for example, cattle, sheep, pigs, chickens, and geese. Suitable formulations are administered orally to the animals with the drinking water or feed. The dosages and formulations that are suitable depend on the species.

Before a pesticide can be used or sold commercially, such pesticide undergoes lengthy evaluation processes by various governmental authorities (local, regional, state, national, international). Voluminous data requirements are specified by regulatory authorities and must be addressed through data generation and submission by the product registrant or by another on the product registrant's behalf. These governmental authorities then review such data and if a determination of safety is concluded, provide the potential user or seller with product registration approval. Thereafter, in that locality where the product registration is granted and supported, such user or seller may use or sell such pesticide.

The headings in this document are for convenience only and must not be used to interpret any portion thereof.

What is claimed is:

1. A synergistic composition, comprising:
(a) 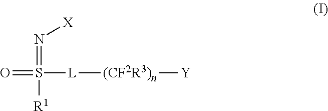
wherein
X represents NO₂, CN or COOR⁴;
L represents a single bond or R¹, S and L taken together represent a 5- or 6-membered ring;
R¹ represents methyl or ethyl;
R² and R³ independently represent hydrogen, methyl, ethyl, fluoro, chloro or bromo;
n is an integer from 0-3;
Y represents 6-halopyridin-3-yl, 6-(C₁-C₄)alkylpyridin-3-yl, 6-halo(C₁-C₄)alkylpyridin-3-yl, 6-(C₁-C₄)alkoxypyridin-3-yl, 6-halo(C₁-C₄)alkoxypyridin-3-yl, 2-chlorothiazol-4-yl, or 3-chloroisoxazol-5-yl when n=0-3 and L represents a single bond, or Y represents hydrogen, C₁-C₄ alkyl, phenyl, 6-halopyridin-3-yl, 6-(C₁-C₄)alkylpyridin-3-yl, 6-halo(C₁-C₄)alkylpyridin-3-yl, 6-(C₁-C₄)alkoxypyridin-3-yl, 6-halo(C₁-C₄)alkoxypyridin-3-yl, 2-chlorothiazol-4-yl, or 3-chloroisoxazol-5-yl when n=0-1 and R¹, S and L taken together represent a 5- or 6-membered ring; and
R⁴ represents C₁-C₃ alkyl; and
(b) an organophosphorous herbicide.

2. The synergistic composition of claim 1, wherein (a) is a cyanosulfoximine compound according to formula (I).

3. The synergistic composition of claim 1, wherein
(a) is 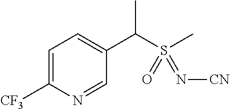 [SMILES: CC(c1ccc(C(F)(F)F)nc1)S(C)(=O)=NC#N]
and
(b) is glufosinate or glyphosate.

4. The synergistic composition of claim 1, further comprising an ammonium salt.

5. The synergistic composition of claim 4, wherein the ammonium salt is ammonium sulfate.

6. The synergistic composition of claim 1, further comprising at least one other pesticide.

7. The synergistic composition of claim 1, further comprising at least one other compound selected from antibiotic insecticides, macrocyclic lactone insecticides, avermectin insecticides, milbemycin insecticides, spinosyn insecticides, arsenical insecticides, botanical insecticides, carbamate insecticides, benzofuranyl methylcarbamate insecticides, dimethylcarbamate insecticides, oxime carbamate insecticides, phenyl methylcarbamate insecticides, diamide insecticides, desiccant insecticides, dinitrophenol insecticides, fluorine insecticides, formamidine insecticides, fumigant insecticides, inorganic insecticides, insect growth regulators, chitin synthesis inhibitors, juvenile hormone mimics, juvenile hormones, moulting hormone agonists, moulting hormones, moulting inhibitors, precocenes, nereistoxin analogue insecticides, nicotinoid insecticides, nitroguanidine insecticides, nitromethylene insecticides, pyridylmethylamine insecticides, organochlorine insecticides, organophosphorus insecticides, oxadiazine insecticides, oxadiazolone insecticides, phthalimide insecticides, pyrazole insecticides, pyrethroid insecticides, pyrimidinamine insecticides, pyrrole insecticides, tetramic acid insecticides, tetronic acid insecticides, thiazole insecticides, thiazolidine insecticides, thiourea insecticides, and urea insecticides.

8. The synergistic composition of claim 1, further comprising at least one other compound selected from 1,2-dichloropropane, 1,3 dichloropropene, abamectin, acephate, acetamiprid, acethion, acetoprole, acrinathrin, acrylonitrile, alanycarb, aldicarb, aldoxycarb, aldrin, allethrin, allosamidin, allyxycarb, alpha-cypermethrin, alpha-endosulfan, amidithion, aminocarb, amiton, amitraz, anabasine, athidathion, azadirachtin, azamethiphos, azinphos-ethyl, azinphos-methyl, azothoate, barium hexafluorosilicate, barthrin, bendiocarb, benfuracarb, bensultap, beta-cyfluthrin, beta-cypermethrin, bifenthrin, bioallethrin, bioethanomethrin, biopermethrin, bioresmethrin, bistrifluoron, borax, boric acid, boric acid, bromfenvinfos, bromocyclen, bromo-DDT, bromophos, bromophos-ethyl, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chlorantraniliprole, chlorbicyclen, chlordane, chlordecone, chlordimeform, chlorethoxyfos, chlorfenapyr, chlorfenvinphos, chlorfluazuron, chlormephos, chloroform, chloropicrin, chlorphoxim, chlorprazophos, chlorpyrifos, chlorpyrifos-methyl, chlorthiophos, chromafenozide, cinerin I, cinerin II, cismethrin, cloethocarb, closantel, clothianidin, copper acetoarsenite, copper arsenate, copper naphthenate, copper oleate, coumaphos, coumithoate, crotamiton, crotoxyphos, crufomate, cryolite, cyanofenphos, cyanophos, cyanthoate, cyclethrin, cycloprothrin, cyfluthrin, cyhalothrin, cypermethrin, cyphenothrin, cyromazine, cythioate, DDT, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, diatomaceous earth, diazinon, dicapthon, dichlofenthion, dichlorvos, dicresyl, dicrotophos, dicyclanil, dieldrin, diflubenzuron, dilor, dimefluthrin, dimefox, dimetan, dimethoate, dimethrin, dimethylvinphos, dimetilan, dinex, dinoprop, dinosam, dinotefuran, diofenolan, dioxabenzofos, dioxacarb, dioxathion, disulfoton, dithicrofos, d-limonene, DNOC, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate-methyl, ethoprophos, ethyl formate, ethyl-DDD, ethylene dibromide, ethylene dichloride, ethylene oxide, etofenprox, etrimfos, EXD, famphur, fenamiphos, fenazaflor, fenchlorphos, fenethacarb, fenfluthrin, fenitrothion, fenobucarb, fenoxacrim, fenoxycarb, fenpirithrin, fenpropathrin, fensulfothion, fenthion, fenthion-ethyl, fenvalerate, fipronil, flonicamid, flubendiamide, flucofuron, flucycloxuron, flucythrinate, flufenerim, flufenoxuron, flufenprox, fluvalinate, fonofos, formetanate, formothion, formparanate, fosmethilan, fospirate, fosthietan, furathiocarb, furethrin, gamma-cyhalothrin, gamma-HCH, halfenprox, halofenozide, HCH, HEOD, heptachlor, heptenophos, heterophos, hexaflumuron, HHDN, hydramethylnon, hydrogen cyanide, hydroprene, hyquincarb, imidacloprid, imiprothrin, indoxacarb, iodomethane, IPSP, isazofos, isobenzan, isocarbophos, isodrin, isofenphos, isoprocarb, isoprothiolane, isothioate, isoxathion, ivermectin, jasmolin I, jasmolin II, jodfenphos, juvenile hormone I, juvenile hormone II, juvenile hormone III, kelevan, kinoprene, lambda-cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfenfos, metaflumizone, methacrifos, methamidophos, methidathion, methiocarb, methocrotophos, methomyl, methoprene, methoxychlor, methoxyfenozide, methyl bromide, methylchloroform, methylene chloride, metofluthrin, metolcarb, metoxadiazone, mevinphos, mexacarbate, milbemectin, milbemycin oxime, mipafox, mirex, monocrotophos, morphothion, moxidectin, naftalofos, naled, naphthalene, nicotine, nifluridide, nitenpyram, nithiazine, nitrilacarb, novaluron, noviflumuron, omethoate, oxamyl, oxydemeton-methyl, oxydeprofos, oxydisulfoton, para-dichlorobenzene, parathion, parathion-methyl, penfluoron, pentachlorophenol, permethrin, phenkapton, phenothrin, phenthoate, phorate, phosalone, phosfolan, phosmet, phosnichlor, phosphamidon, phosphine, phoxim, phoxim-methyl, pirimetaphos, pirimicarb, pirimiphos-ethyl, pirimiphos-methyl, potassium arsenite, potassium thiocyanate, pp′-DDT, prallethrin, precocene I, precocene II, precocene III, primidophos, profenofos, profluthrin, promacyl, promecarb, propaphos, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, rotenone, ryania, sabadilla, schradan, selamectin, silafluofen, silica gel, sodium arsenite, sodium fluoride, sodium hexafluorosilicate, sodium thiocyanate, sophamide, spinetoram, spinosad, spiromesifen, spirotetramat, sulcofuron, sulfluramid, sulfotep, sulfuryl fluoride, sulprofos, tau-fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetramethrin, theta-cypermethrin, thiacloprid, thiamethoxam, thicrofos, thiocarboxime, thiocyclam, thiodicarb, thiofanox, thiometon, thiosultap, thuringiensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb, zeta-cypermethrin, zolaprofos, and α-ecdysone.

9. The synergistic composition of claim 1, further comprising at least one compound selected from acaricides, algicides, antifeedants, avicides, bactericides, bird repellents, chemosterilants, fungicides, herbicide safeners, insect attractants, insect repellents, mammal repellents, mating disrupters, molluscicides, plant activators, plant growth regulators, rodenticides, defoliants, desiccants, disinfectants, semiochemicals, and virucides.

10. The synergistic composition of claim 1, further comprising at least one compound selected from acetyl choline esterase inhibitors, sodium channel modulators, chitin biosynthesis inhibitors, GABA-gated chloride channel antagonists, GABA and glutamate-gated chloride channel agonists, acetyl choline receptor agonists, MET I inhibitors, Mg-stimulated ATPase inhibitors, nicotinic acetylcholine receptors, Midgut membrane disrupters, and oxidative phosphorylation disrupters.

11. The synergistic composition of claim 1, further comprising at least one of the following compounds: piperonyl butoxide, piprotal, propyl isome, sesamex, sesamolin, and sulfoxide.

12. A process, comprising applying the synergistic composition of claim 1 to a locus to control pests.

13. A process of applying the synergistic composition of claim 1 to a seed.

14. A process of applying the synergistic composition of claim 1 to a seed that has been genetically transformed to express one or more specialized traits.

15. A process of applying the synergistic composition of claim 1 to a genetically transformed plant that has been genetically transformed to express one or more specialized traits.

16. A process of orally administering or applying the synergistic composition of claim 1 to an animal.
